(19) United States
(12) Patent Application Publication
(10) Pub. No.: US 2007/0248008 A1
(43) Pub. Date: Oct. 25, 2007

(54) Management support method, management support system, management support apparatus and recording medium

(75) Inventors: Fumiharu Etoh, Fukuoka (JP); Yasuo Inoue, Fukuoka (JP); Ryuichi Ebuchi, Fukuoka (JP); Kenichi Takemura, Fukuoka (JP)

Correspondence Address: BINGHAM MCCUTCHEN LLP, 2020 K Street, N.W., Intellectual Property Department, WASHINGTON, DC, 20006, US

(73) Assignee: FUJITSU LIMITED

(21) Appl. No.: 11/494,718

(22) Filed: Jul. 28, 2006

(30) Foreign Application Priority Data
Apr. 24, 2006 (JP) 2006-119701

(51) Int. Cl. H04L 12/26

(52) U.S. Cl. 370/230

(57) ABSTRACT

In the present invention, the communication quality of a communication network that provides a plurality of types of communication services is measured, and the measured communication quality is compared with a preset criterion to determine an abnormality type and whether or not management is necessary. When a determination is made that management is necessary, information about management is extracted from a database in which information about management with respect to abnormalities is recorded in association with communication network devices constituting the communication network, the service types of communication services and abnormality types, based on a communication network device, service type and abnormality type corresponding to the measured communication quality, and then an output such as a notification and control of the device based on the extracted information is given.

### CROSS-REFERENCE TO RELATED APPLICATION

This non-provisional application claims priority under 35 U.S.C. §119(a) on Patent Application No; 2006-119701 filed in Japan on Apr. 24, 2006, the entire contents of which are hereby incorporated by reference.

### BACKGROUND OF THE INVENTION

1. Field of the Invention

The present invention relates to a management support method for supporting management with respect to abnormalities in communication services, a management support system adopting the management support method, a management support apparatus for use in the management support system, and a recording medium for realizing the management support apparatus. In particular, the present invention relates to a management support method, management support system, management support apparatus and recording medium for enabling detection and control of abnormalities in the communication quality of a communication network that provides a plurality of types of communication services.

2. Description of Related Art

A communication system for providing a plurality of communication services, such as VoIP and streaming, through one communication network has been spread. In a widespread conventional communication system, the operations of measuring the communication quality, detecting quality abnormalities, detecting troubles, and so on are performed for each type of communication service.

For example, Japanese Patent Application Laid-Open No. 2002-101097 discloses a system that monitors the state of achievement in maintaining possible limited service quality by a specific monitoring method in a network, and detects occurrence of abnormalities in the limited service quality.

### BRIEF SUMMARY OF THE INVENTION

However, the conventional system does not perform operations such as detection of quality abnormalities in a plurality of communication services, and detection of troubles. Moreover, in the conventional method disclosed in the Japanese Patent Application Laid-Open No. 2002-101097, since management such as specifying the cause of a detected quality abnormality is left to a skilled person's determination, this method has problems, for example, the contents of operations may vary depending on the person in charge, and it is necessary to collect and educate excellent persons in charge of the system.

The present invention has been made with the aim of solving the above problems, and it is an object of the present invention to provide a management support method capable of detecting abnormalities in the communication quality for a plurality of service types and capable of performing uniform management regardless of the person in charge by determining an abnormality type and whether or not management is necessary, based on the communication quality measured for a plurality of types of communication services, and outputting prerecorded information about management when a determination is made that management is necessary, and to provide a management support system adopting the management support method, a management support apparatus for use in the management support system, and a recording medium for realizing the management support apparatus.

A management support method according to a first aspect is a management support method using a management support apparatus for supporting management with respect to abnormalities in communication services, and characterized by measuring the communication quality of a communication network that provides a plurality of types of communication services; determining an abnormality type and whether management is necessary or not by comparing the measured communication quality with a preset criterion; extracting information about management from a database in which information about management with respect to abnormalities is recorded in association with communication network devices constituting the communication network, service types of communication services and abnormality types, based on a communication network device, service type and abnormality type corresponding to the measured communication quality, when a determination is made that management is necessary; and giving an output based on the extracted information.

In this invention, it is possible to detect abnormalities in the communication quality for a plurality of service types, and it is also possible to perform uniform management regardless of the person in charge.

A management support system according to a second aspect is a management support system for supporting management with respect to abnormalities in communication services, and characterized by comprising: a measurement device for measuring communication quality of a communication network that provides a plurality of types of communication services, for each of communication network devices constituting the communication network and service types of communication services; a management database for recording information about management with respect to abnormalities in association with communication network devices, service types and abnormality types; means for determining an abnormality type and whether management is necessary or not by comparing the communication quality measured by the measurement device with a preset criterion; extracting means for extracting information about management from the management database, based on a communication network device, service type and abnormality type corresponding to the measured communication quality, when a determination is made that management is necessary; and means for giving an output based on the extracted information.

In this invention, it is possible to detect abnormalities in the communication quality for a plurality of service types, and it is also possible to perform uniform management regardless of the person in charge.

A management support system according to a third aspect is based on the second aspect, and characterized by further comprising a communication control device for performing control concerning a plurality of types of communication services provided by the communication network, wherein the extracting means is constructed to extract information about a control instruction for causing the communication control device to perform control concerning communication services.

In this invention, by causing the communication control device to perform predetermined control as management with respect to an abnormality, it is possible to automatically manage the abnormality.

A management support apparatus according to a fourth aspect is a management support apparatus for supporting management with respect to abnormalities in communication services, and characterized by comprising: means for obtaining communication quality measured for each of communication network devices constituting a communication network that provides a plurality of types of communication services, and service types of communication services; means for determining an abnormality type and whether management is necessary or not by comparing the obtained communication quality with a preset criterion; means for extracting information about management from a management database in which information about management with respect to abnormalities are recorded, based on a communication network device, service type and abnormality type corresponding to the measured communication quality, when a determination is made that management is necessary; and means for giving an output based on the extracted information.

In this invention, it is possible to detect abnormalities in the communication quality for a plurality of service types, and it is also possible,to perform uniform management regardless of the person in charge.

A recording medium according to a fifth aspect is a recording medium storing a computer program for causing a computer to support management with respect to abnormalities in communication services, and characterized by said computer program comprising the steps of causing the computer to obtain communication quality measured for each of communication network devices constituting a communication network that provides a plurality of types of communication services, and service types of communication services; causing the computer to determine an abnormality type and whether management is necessary or not by comparing the obtained communication quality with a preset criterion; and causing the computer to extract information about management from a database in which information about management with respect to abnormalities is recorded in association with communication network devices, service types and abnormality types, based on a communication network device, service type and abnormality type corresponding to the measured communication quality, when a determination is made that management is necessary.

In this invention, by executing the computer program with a computer such as a server computer, the computer operates as a management support apparatus, and can detect abnormalities in the communication quality for a plurality of service types and can also perform uniform management regardless of the person in charge.

A management support method, management support system, management support apparatus and recording medium according to the present invention measure the communication quality of a communication network that provides a plurality of types of communication services; determine an abnormality type and whether management is necessary or not by comparing the measured communication quality with a preset criterion; extract information about management from a database in which information about management with respect to abnormalities is recorded in association with communication network devices constituting the communication network, service types of communication services and abnormality types, based on a communication network device, service type and abnormality type corresponding to the measured communication quality, when a determination is made that management is necessary; and giving an output, such as a notification and control of the device, based on the extracted information. In the present invention with this structure, since an abnormality type and whether or not management is necessary are determined based on the communication quality measured for a plurality of types of communication services, it is possible to detect abnormalities in the communication quality for a plurality of types of communication services at once. Moreover, by performing management based on the information extracted from the database prerecording information about management, it is possible to perform uniform management without depending on the technique and knowledge of the person in charge, and thus it is possible to provide advantageous effects, such as reducing the burden for management, including collecting and educating the person in charge.

The above and further objects and features of the invention will more fully be apparent from the following detailed description with accompanying drawings.

### BRIEF DESCRIPTION OF THE SEVERAL VIEWS OF THE DRAWINGS

FIG. 1 is an explanatory view conceptually showing the structure of a management support system according to Embodiment 1 of the invention;

FIG. 2 is a block diagram showing the structure of a management support apparatus according to Embodiment 1 of the invention;

FIG. 3 is an explanatory view conceptually showing the recorded contents of a management method database in the management support apparatus according to Embodiment 1 of the invention;

FIG. 4 is an explanatory view conceptually showing the recorded contents of a management type database in the management support apparatus according to Embodiment 1 of the invention;

FIG. 5 is an explanatory view conceptually showing the recorded contents of a management criteria database in the management support apparatus according to Embodiment 1 of the invention;

FIG. 6 is a sequence view showing a quality abnormality and trouble detecting process performed in the management support apparatus according to Embodiment 1 of the invention;

FIG. 7 is an explanatory view conceptually showing quality measurement result information in the management support apparatus according to Embodiment 1 of the invention;

FIG. 8 is an explanatory view conceptually showing a trigger information notification in the management support apparatus according to Embodiment 1 of the invention;

FIG. 9 is an explanatory view conceptually showing quality abnormality information in the management support apparatus according to Embodiment 1 of the invention;

FIG. 10 is an explanatory view conceptually showing a control request in the management support apparatus according to Embodiment 1 of the invention;

FIG. 11 is an explanatory view showing trouble information in the management support apparatus according to Embodiment 1 of the invention;

FIG. 12 is a block diagram showing the structure of a management, support apparatus according to Embodiment 2 of the invention;

FIG. 13 is an explanatory view conceptually showing the recorded contents of a quality abnormality information result record database in the management support apparatus according to Embodiment 2 of the invention;

FIG. 14 is an explanatory view conceptually showing the recorded contents of a trouble information result record database in the management support apparatus according to Embodiment 2 of the invention;

FIG. 15 is a sequence view showing a result recording process performed in the management support apparatus according to Embodiment 2 of the invention;

FIG. 16 is a sequence view showing a quality abnormality detecting process performed in the management support apparatus according to Embodiment 2 of the invention;

FIG. 17 is an explanatory view conceptually showing a recorded content request in the management support apparatus according to Embodiment 2 of the invention;

FIG. 18 is a sequence view showing a trouble detecting process performed in the management support apparatus according to Embodiment 2 of the invention;

FIG. 19 is an explanatory view conceptually showing trouble information in the management support apparatus according to Embodiment 2 of the invention;

FIG. 20 is a sequence view showing a trouble detecting process performed in a management support apparatus according to Embodiment 3 of the invention;

FIG. 21 is an explanatory view showing a control notification in the management support apparatus according to Embodiment 3 of the invention;

FIG. 22 is a block diagram showing the structure of a management support apparatus according to Embodiment 4 of the invention;

FIG. 23 is an explanatory view conceptually showing the recorded contents of a network structure database in a management support apparatus according to Embodiment 4 of the invention;

FIG. 24 is a sequence view showing a result recording process performed in the management support apparatus according to Embodiment 4 of the invention;

FIG. 25 is a sequence view showing a trouble detecting process performed in the management support apparatus according to Embodiment 4 of the invention;

FIG. 26 is an explanatory view conceptually showing an information request in the management support apparatus according to Embodiment 4 of the invention;

FIG. 27 is an explanatory view conceptually showing quality abnormality information associated with network structure information in the management support apparatus according to Embodiment 4 of the invention;

FIG. 28 is an explanatory view conceptually showing trouble information associated with the network structure information in the management support apparatus according to Embodiment 4 of the invention;

FIG. 29 is a block diagram showing the structure of a management support apparatus according to Embodiment 5 of the invention;

FIG. 30 is an explanatory view conceptually showing the recorded contents of a packet information database in a management support apparatus according to Embodiment 5 of the invention;

FIG. 31 is a sequence view showing a result recording process performed in the management support apparatus according to Embodiment 5 of the invention;

FIG. 32 is a sequence view showing a trouble detecting process performed in the management support apparatus according to Embodiment 5 of the invention;

FIG. 33 is an explanatory view conceptually showing an information request in the management support apparatus according to Embodiment 5 of the invention;

FIG. 34 is an-explanatory view conceptually showing quality abnormality information associated with packet information in the management support apparatus according to Embodiment 5 of the invention;

FIG. 35 is an explanatory view conceptually showing trouble information associated with packet information in the management support apparatus according to Embodiment 5 of the invention;

FIG. 36 is a block diagram showing the structure of a management support apparatus according to Embodiment 6 of the invention;

FIG. 37 is an explanatory view conceptually showing the recorded contents of an operation result database in the management support apparatus according to Embodiment 6 of the invention;

FIG. 38 is a sequence view showing a result recording process performed in the management support apparatus according to Embodiment 6 of the invention;

FIG. 39 is a sequence view showing a trouble detecting process performed in the management support apparatus according to Embodiment 6 of the invention;

FIG. 40 is an explanatory view conceptually showing an information request in the management support apparatus according to Embodiment 6 of the invention;

FIG. 41 is an explanatory view conceptually showing quality abnormality information associated with operation result information in the management support apparatus according to Embodiment 6 of the invention;

FIG. 42 is an explanatory view conceptually showing trouble information associated with packet information in the management support apparatus according to Embodiment 6 of the invention;

FIG: 43 is a block diagram showing the structure of a management support apparatus according to Embodiment 7 of the invention;

FIG. 44 is a sequence view showing the processes performed in the management support apparatus according to Embodiment 7 of the invention;

FIG. 45 is a sequence view showing a quality abnormality managing process performed in the management support apparatus according to Embodiment 7 of the invention;

FIG. 46 is an explanatory view conceptually showing an information request in the management support apparatus according to Embodiment 7 of the invention; and

FIG. 47 is an explanatory view conceptually showing quality abnormality information associated with operation result information in the management support apparatus according to Embodiment 7 of the invention.

### DETAILED DESCRIPTION OF THE INVENTION

The following description will explain in detail the present invention, based on the drawings illustrating some embodiments thereof.

### Embodiment 1

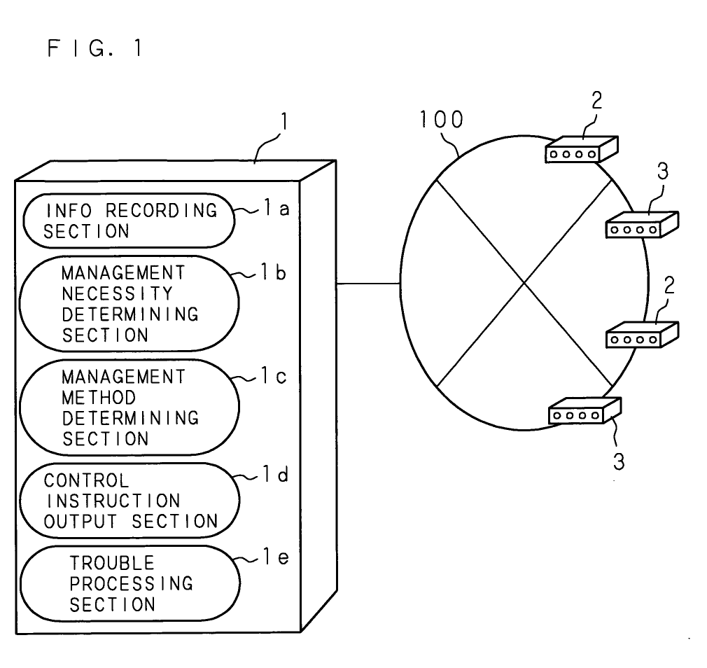

FIG. 1 is an explanatory view conceptually showing the structure of a management support system according to Embodiment 1 of the invention. In FIG. 1, the number 1 represents a management support apparatus using a computer, such as a server computer, for supporting management with respect to abnormalities in a plurality of types of communication services, such as VoIP (Voice over IP), TV phone and streaming, provided for customers. The management support apparatus 1 is connected to a measurement device 2 for measuring the communication quality of a communication network 100 providing communication services, and a communication control device 3 for controlling communications with respect to the communication network 100. A plurality of measurement devices 2 and communication control devices 3 are arranged within the communication network 100 as devices (communication network devices), such as routers, switches and load balancers, forming the communication network 100. Note that it may be possible to provide a single device with the functions of the measurement device 2 and communication control device 3.

The management support apparatus 1 comprises various kinds of processing sections, such as an information recording section 1a for recording information about how to manage abnormalities in communication services, for example; a management necessity determining section 1b for determining whether or not management is necessary, based on the communication quality measured by the measurement device 2; a management method determining section 1c for determining a management method, based on various kinds of information recorded in the information recording section 1a, when the management necessity determining section 1b determines that management is necessary; a control instruction output section 1d for outputting a control instruction to control the communication control device 3 based on the management method determined by the management method determining section 1c; and a trouble processing section 1e for detecting a trouble in the communication network 100, based on various kinds of information recorded in the information recording section 1a, and outputting information about the trouble.

Various kinds of processing sections are, for example, program modules to be executed by the management support apparatus 1, and the functions of the various kinds of processing sections are realized by executing the program modules.

Although FIG. 1 shows a structure where one server computer is used as the management support apparatus 1, the present invention is not limited to this. It may be possible to spread the functions by providing different devices with various kinds of processing sections, respectively, and executing the respective processing sections. In short, a group of server computers may be used as the management support apparatus 1 of the present invention.

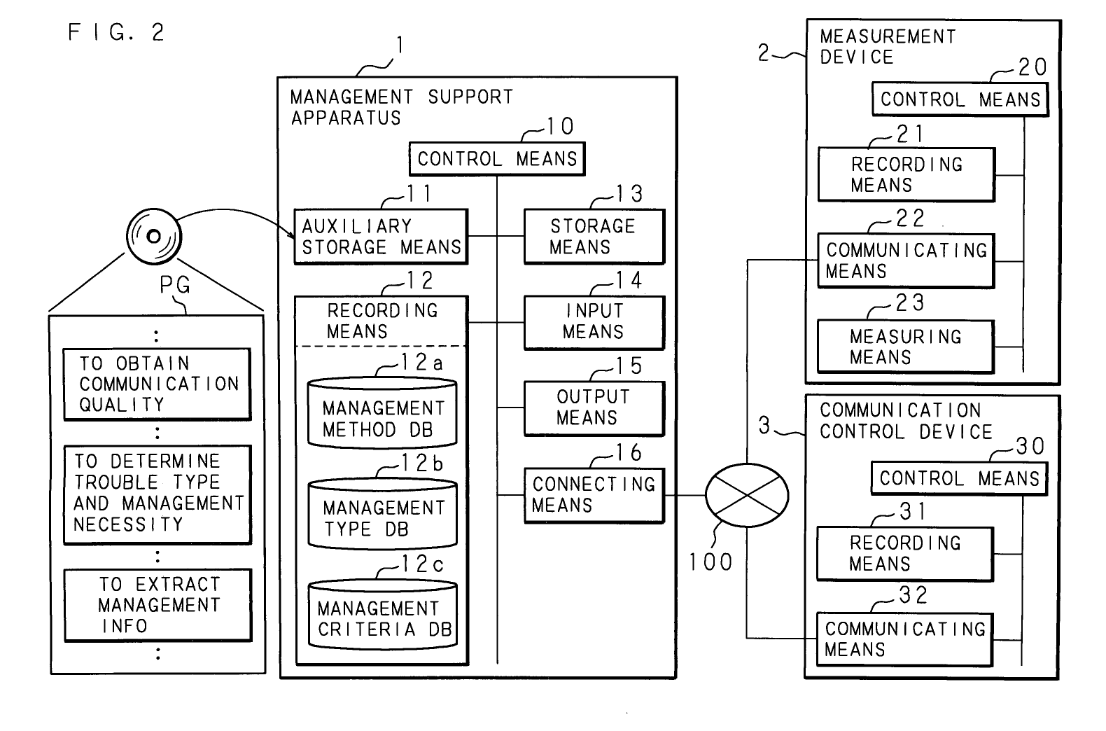

FIG. 2 is a block diagram showing the structure of the management support apparatus 1 according to Embodiment 1 of the invention. The management support apparatus 1 comprises control means 10 such as a CPU (Central Processing Unit) for controlling the entire apparatus, auxiliary storage means 11 such as a CD-ROM drive for reading various kinds of information from a recording medium, such as a CD-ROM (Compact Disc Read Only Memory), on which various kinds of information such as a computer program PG-and data for the management support apparatus are recorded; recording means 12 such as a hard disk for recording various kinds of information read by the auxiliary storage means 11, and storage means 13 such as a RAM (Random Access Memory) for temporally storing information.

By storing the computer program PG recorded on the recording means 12 in the storage means 13 and executing it under the control of the control means 10, the computer operates as the management support apparatus 1 of the present invention. By executing the computer program PG, the management support apparatus 1 of the present invention forms various kinds of processing sections, such as the above-mentioned information recording section 1a, management necessity determining section 1b, management method determining section 1c, control instruction output section 1d and trouble processing section 1e, in the recording means 12 and/or the storage means 13 as the program modules to be executed based-on the control of the control means 10.

Moreover, in the recording means 12, various kinds of databases, such as a management method database 12a, a management type database 12b and a management criteria database 12c, are formed as databases to be managed in the information recording section la. Note that the management method database 12a, management type database 12b and management criteria database 12c are not necessarily formed in the recording means 12 of the management support apparatus 1, and may be formed in recording means of other device if they can be managed by the information recording section 1a.

Further, the management support apparatus 1 comprises input means 14 such as a mouse and a keyboard; output means 15 such as a monitor and a printer; and connecting means 16 for connecting to the measurement device 2 and the communication control device 3 through the communication network 100. When transmitting an output, for example, a control instruction, to other device, the connecting means 16 is used as means for outputting the instruction to the other device.

The measurement device 2 comprises control means 20; recording means 21 for recording information such as routing information; communicating means 22 having a communication port and a package for performing communication processing by being connected to the communication network 100; and measuring means 23 for measuring the communication quality of a communication service provided over the communication network 100. The package of the communicating means 22 is an interface module provided separately for each type of interfaces, such as ISDN, ATM and IP. Each package has one or a plurality of communication ports, and the measurement device 2 is connected to the communication network 100 through the communication port.

The communication control device 3 comprises control means 30, recording means 31, and communicating means 32.

Next, the following description will explain processing performed by various devices included in the management support system according to Embodiment 1 of the present invention. When executing the processing, information necessary for the management method database 12a, management type database 12b and management criteria database 12c formed in the management support apparatus 1 is recorded. The information to be recorded with respect to the management method database 12a, management type database 12b and management criteria database 12c is received by some method, such as reading from an information recording medium by the auxiliary storage means 11, receiving an operation from the input means 14, or receiving via the connecting means 16.

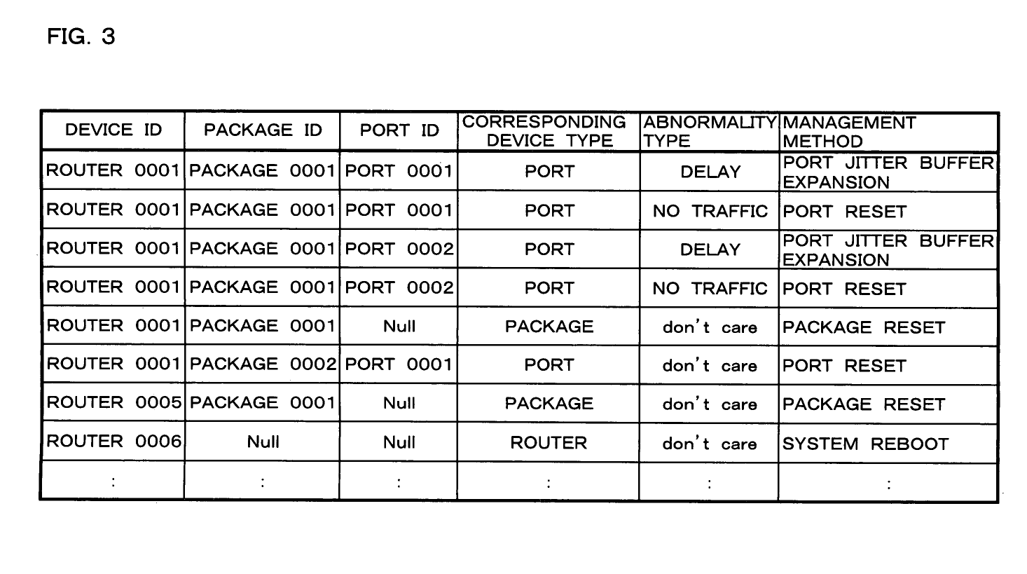

FIG. 3 is an explanatory view conceptually showing the recorded contents of the management method database 12a in the management support apparatus 1 according to Embodiment 1 of the invention. In the management method database 12a, various kinds of information about a record that associates items such as the measurement device ID, package ID, port ID, corresponding device type, abnormality type, and management method with each other, are recorded as management method information indicating a management method for an abnormality in the communication quality.

In the Measurement Device ID field, information, such as “Router 001” and “Router 005”, specifying a measurement device 2 performing measurement is recorded. In the Package ID field, information, such as “Package 0001” and “Package 0002”, specifying a package as an interface module provided for each type of interface, such as ISDN, ATM and IP, for the measurement device 2 is recorded. In the Port ID field, information, such as “Port 0001” and “Port 0002”, specifying one or a plurality of communication ports provided for each package and used as the communicating means 22 is recorded. In the corresponding device type field, information indicating the level of the type of a device or a structure, such as a “Router”, “Package” and “Port”, corresponding to the information related to this record is recorded. For example, it can be read from the information about the corresponding device type that the information about the abnormality type and the management method listed in the top record where the corresponding device type is “port” indicates an abnormality type and a management method for the port. In the field “Abnormality type”, information indicating the type of abnormality in the communication quality such as “delay”, “no traffic”, and “don't care” is recorded. When the type of the abnormality is “don't care”, it means that management does not depend on the type of abnormality. For example, the record shown on the fifth line from the top indicates that the method shown in the management method field of this record, namely “package reset”, is performed for the abnormality in the package regardless of the abnormality type. Recorded in the management method field is information indicating a control method for managing the abnormality, such as port jitter buffer expansion”, “port reset”, and “system reboot”.

When the information in the fields such as Package ID, Port ID is “Null”, it means that the information concerning these fields has not been set in this record. For example, in the record shown on the fifth line from the top, Port ID is “Null” and Corresponding device type is “Package”, and thus this record is information about the package, and information indicating a port that is a lower component than the package is not set. In the record shown on the eighth line from the top, Package ID and Port ID are both “Null”, and Corresponding device type is “Router”. Thus, this record is information about the router, and information indicating a package and a port that are lower components than the router (device) is not set.

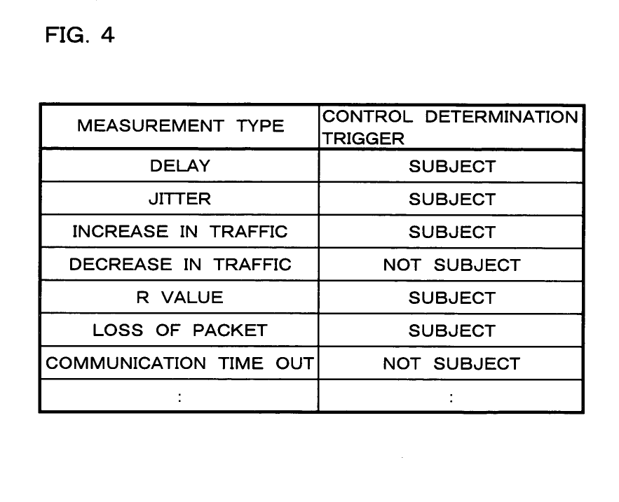

FIG. 4 is an explanatory view conceptually showing the recorded contents of the management type database 12b in the management support apparatus 1 according to Embodiment 1 of the invention. In the management type database 12b, various kinds of information are recorded in a record that associates the items “Measurement Type” and “Control Determination Trigger” with each other. Recorded in the Measurement Type field is information, such as “delay”, “jitter”and “communication time out”, which corresponds to the abnormality type in the management method database 12a. Recorded in the Control Determination Trigger field is information indicating whether or not an abnormality corresponding to the associated abnormality type is subject to management; The example shown in FIG. 4 indicates that measurement types such as “delay” and “jitter” are subject to management, but a measurement type such as “communication time out” is not subject to management.

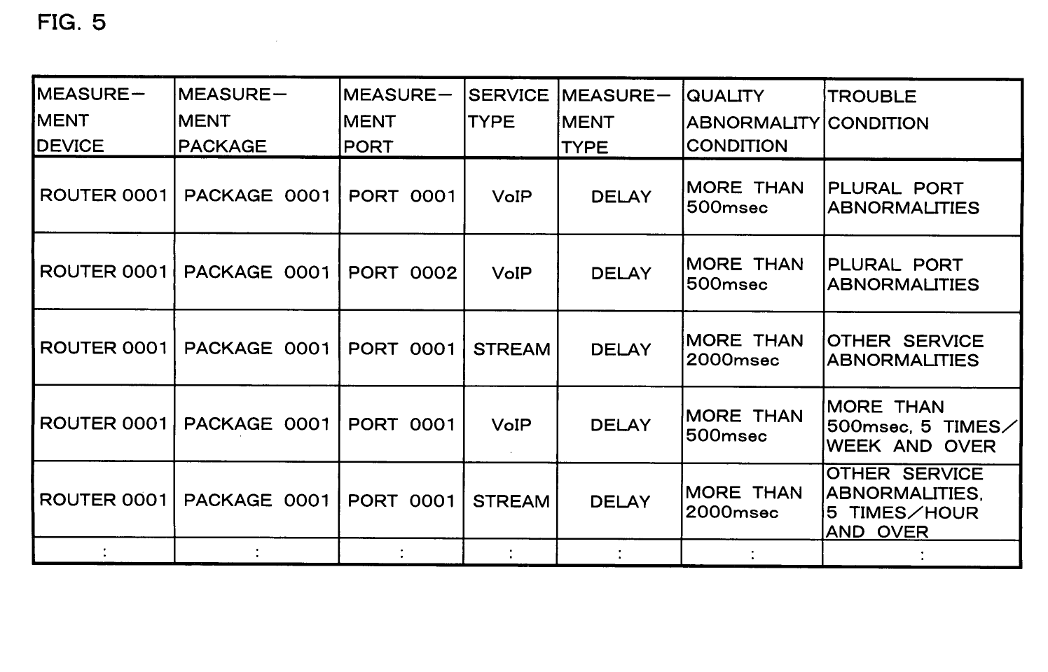

FIG. 5 is an explanatory view conceptually showing the recorded contents of the management criteria database 12c in the management support apparatus 1 according to Embodiment 1 of the invention. In the management criteria database 12c, various kinds of information about a record that associates items such as the measurement device, measurement package, measurement port, service type, measurement type, quality abnormality condition, and trouble condition with each other are recorded as determination criteria information indicating criteria for determining occurrence of abnormalities in the communication quality.

Recorded in the Measurement Device field is information, such as “Router 0001” and “Router 0005”, corresponding to the measurement device ID in the management method database 12a. Recorded in the Measurement Package field is information, such as “Package 0061” and “Package 0002”, corresponding to the package ID in the management method database 12a. Recorded in the Measurement Port field is information, such as “Port 0001” and “Port 0002”, corresponding to the port ID in the management method database 12a. Recorded in the Service Type field is information, such as “VoIP” and “Stream” indicating the types of services. Recorded in the Measurement Type field is information such as “delay” corresponding to the abnormality type in the management method database 12a. In the Quality Abnormality Condition field, information, such as “more than 500 msec” and “more than 2000 msec”, is recorded as criteria for determining and managing quality abnormalities. Recorded in the Trouble Condition field is information, such as “plural port abnormalities” and “other service abnormality”, indicating troubles causing quality abnormalities.

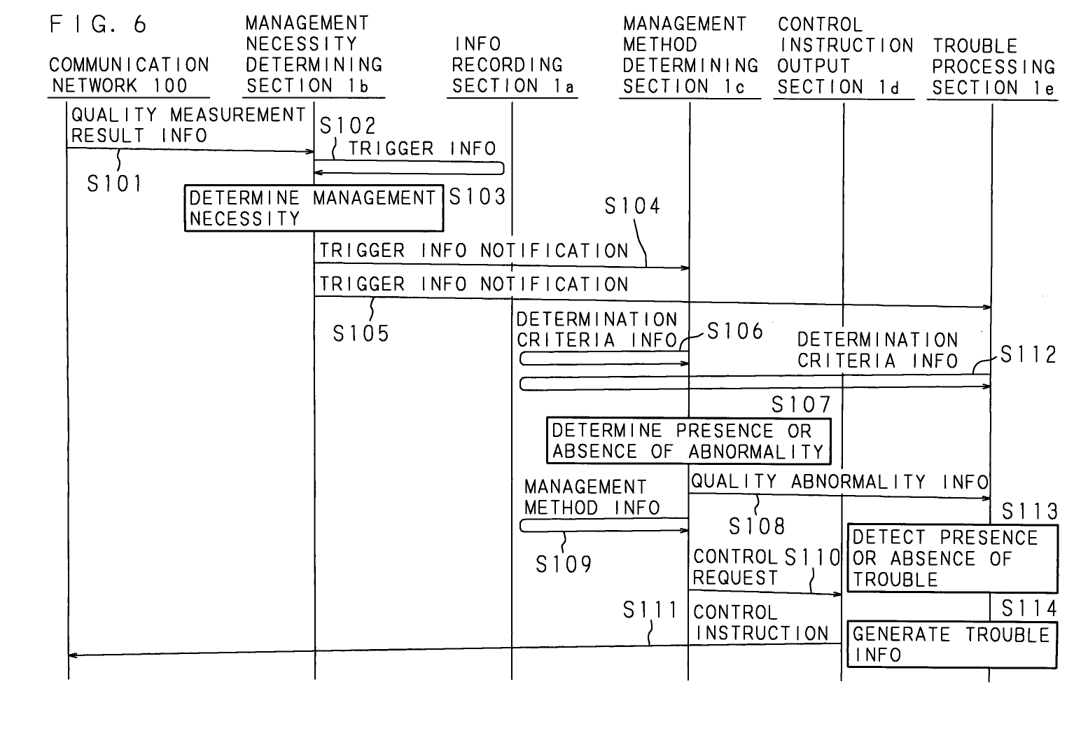

FIG. 6 is a sequence view showing a quality abnormality and trouble detecting process performed in the management support apparatus 1 according to Embodiment 1 of the invention. The measurement device 2 measures the quality of communication service provided through the communication network 100, and transmits the measurement result as quality measurement result information to the management support apparatus 1. The management support apparatus 1 receives (obtains) the quality measurement result information through the processing in the management necessity determining section 1b (S101).

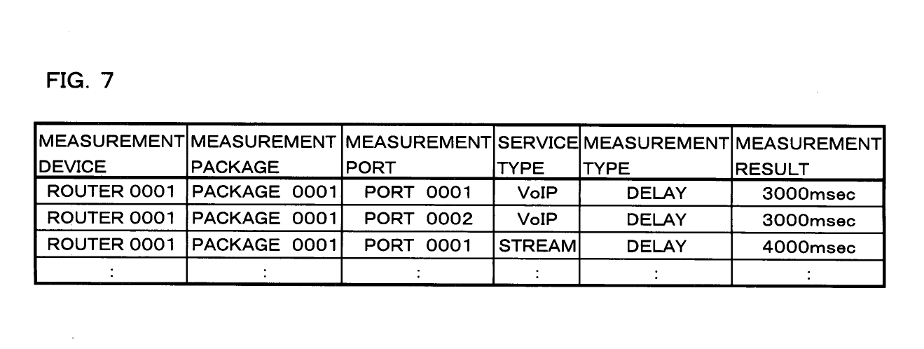

FIG. 7 is an explanatory view conceptually showing the quality measurement result information in the management support apparatus 1 according to-Embodiment 1 of the invention. As shown in FIG. 7, the quality measurement result information received by the management necessity determining section 1b in step S101 includes information about items such as the measurement device, measurement package, measurement port, service type, measurement type, and measurement result. The information shown as the measurement result is a value indicating the quality of the communication service measured by the measurement device 2. The example of the record shown at the top in FIG. 7 indicates that the measurement result “3000 msec” was obtained by measuring the measurement type “delay” under the conditions of the measurement device “Router 0001”—measurement package “Package 0001”—measurement port “Port 0001”—service Type “VoIP”. Moreover, as shown in FIG. 7 in which quality measurement result information including three measurement results is shown, the measurement-device 2 can transmit a plurality of measurement results to the management support apparatus 1.

Go back to the sequence view. The management support apparatus 1 extracts the measurement type and control determination trigger recorded in the management type database 12b in the information recording section 1a as trigger information (criterion) through the processing in the management necessity determining section 1b (S102); and determines whether management, is necessary or not by comparing the measurement type and control determination trigger shown by the extracted trigger information with the measurement type indicated by the quality measurement result information (S103).

In the example of the quality measurement result information shown in FIG. 7, “delay” was measured. Since “delay” is an “object” to be managed for abnormalities in the management type database 12b shown in FIG. 4, the measurement result shown by this quality measurement result information indicates a type that may possibly affect the quality, and thus, if an abnormality has occurred, a determination is made that management is necessary. Note that, in step S103, if a determination is made that the measurement type is not subject to management, the following processes are not performed.

Go back to the sequence view. Through the processing in the management necessity determining section 1b, the management support apparatus 1 sends the quality measurement result information as a trigger information notification to the management method determining section 1c (S104) and further to the trouble processing section 1e (S105).

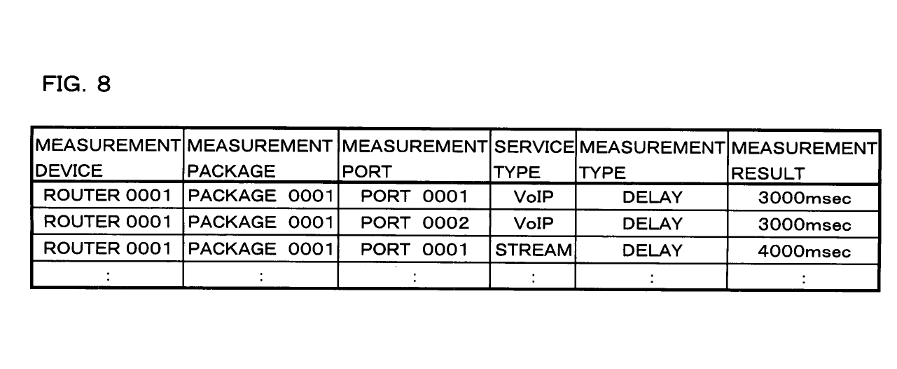

FIG. 8 is an explanatory view conceptually showing the trigger information notification in the management support apparatus 1 according to Embodiment 1 of the invention. As shown in FIG. 8, the trigger information notification sent to the management method determining section 1c and the trouble processing section 1e in steps S104 and S105 by the management necessity determining section 1b includes information about items such as the measurement device, measurement package, measurement port, service type, measurement type, and measurement result. Since the trigger information notification is electronic message information for reporting the contents of the quality measurement result information received by the management necessity determining section 1b to the management method determining section 1c and the trouble processing section 1e, the contents of the information are the same as the quality measurement result information. The management method determining section 1c starts to determine a management method by using the received trigger information notification as a trigger, and the trouble processing section 1e starts to perform trouble processing by using the received trigger information notification as a trigger.

Go back to the sequence view. Through the processing in the management method determining section 1c, the management support apparatus 1 extracts the determination criteria information recorded in the management criteria database 12c in the information recording section 1a (S106), and determines whether or not an abnormality has occurred in the communication quality, based on the extracted determination criteria information and the trigger information notification received from the management necessity determining section 1b (S107).

In step S107, when the three trigger information notifications exemplified in FIG. 8 and the recorded contents of the management criteria database 12c exemplified in FIG. 5 are compared, both of them satisfy the quality abnormality condition, and thus a determination is made that an abnormality has occurred in the communication quality. More specifically, the measurement result of a record shown at the top for the measurement device “Router 0001”—measurement package “Package 0001”—measurement port “Port 0001”—service type “VoIP”—measurement type “delay” is “3000 msec”. The management criterion to be compared with this record is the record shown at the top in FIG. 5. In this record, since the quality abnormality condition is “more than 5000 msec”, a determination is made that an abnormality has occurred in the communication quality, based on the comparison between the quality abnormality condition and the measurement result. Note that, if a determination is made in step S107 that no abnormality has occurred in the communication quality, the following processes are not performed.

Go back to the sequence view. When the management support apparatus 1 determines that an abnormality has occurred in the communication quality, it sends the quality abnormality information indicating that an abnormality has occurred in the communication quality to the trouble processing section 1e through the processing in the management method determining section 1c (S108).

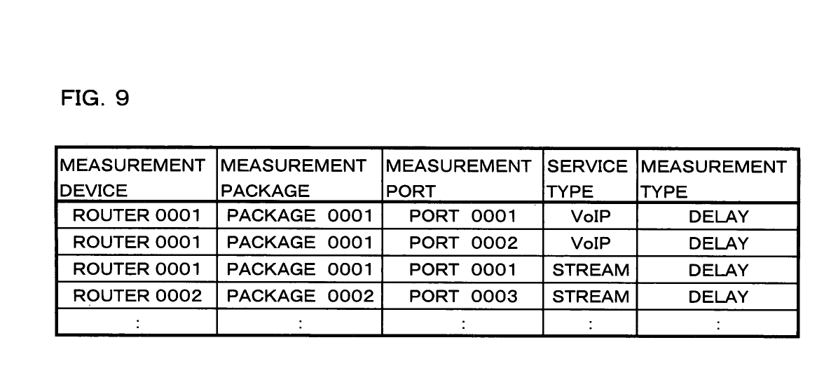

FIG. 9 is an explanatory view conceptually showing the quality abnormality information in the management support apparatus 1 according to Embodiment 1 of the invention. The quality abnormality information is information for reporting the device and place where an abnormality has occurred in the communication quality, and the service type and the type of the abnormality to the trouble processing section 1e. Therefore, as shown in FIG., 9, the quality abnormality information includes information about items such as the measurement device, measurement package, measurement port, service type, and measurement type.

Go back to the sequence view. Through the processing in the management method determining section 1c, the management support apparatus 1 extracts the management method information from the management method database 12a in the information recording section 1a (S109), based on the content of abnormality determined in step S107, more specifically, the content shown by the quality abnormality information in step S108, and sends a control request determined based on the extracted management method information to the control instruction output section 1d (S110). The control instruction output section id transmits (outputs) a control instruction based on the received control request to the communication control device 3 to be controlled over the communication network 100 from the connecting means 16 (output means) through the communication network 100 (S111).

In step S109, as shown in FIG. 9, for example, when the quality abnormality information indicates the measurement device “Router 0001”—measurement-package “Package 0001”—measurement port “Port 0001” and the measurement type “delay”, the management method information to be extracted from the management method database 12a based on this quality abnormally information is the top record exemplified in FIG. 3. In this record, “port jitter buffer expansion” is shown as a management method. Similarly, for a record extracted based on quality abnormality information indicating the measurement port “Port 0002”, “port jitter buffer expansion” is shown as a management method. Thus, in step S110, the management support apparatus 1 determines that the communication control device 3 corresponding to the measurement device “Router 0001”—measurement package “Package 0001”—measurement port “Port 0001”, and the measurement device “Router 0001”—measurement package “Package 0001”—measurement port “Port 0002” is to be managed by control for performing “port jitter buffer expansion”, and sends a control request based on the determined management method to the control instruction output section 1d.

In step S109, if the management method information corresponding to the content indicated by the quality abnormality information is not recorded in the management method database 12a, the management support apparatus 1 determines that management by automatic control is impossible, and then reports the content of the determination that management is impossible to the person in charge and finishes the processing. When the person in charge newly inputs the management method information in response to the report, the processes on and after step S106 are repeated.

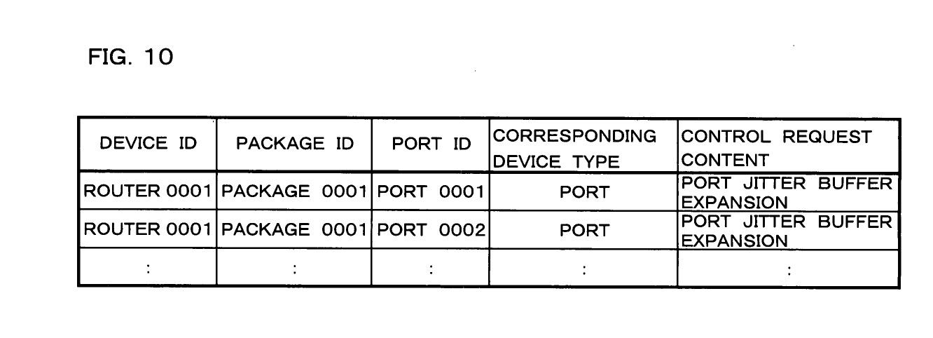

FIG. 10 is an explanatory view conceptually showing a control request in the management support apparatus 1 according to Embodiment 1 of the invention. The control request is an instruction generated based on the management method information, and includes, as shown in FIG. 10, the measurement device ID, package ID, port ID and corresponding device type indicating objects to be controlled, and the control request content indicating the content of control. A control instruction to be transmitted to the communication control device 3 in step S111 is an instruction generated according to the specifications of the communication control device 3 to be controlled based on the control request in step S110, and the actual content is the same as that of the control request shown in FIG. 10.

Upon receipt of the control instruction, the communication control device 3 operates to control the communication related to the communication network 100, based on the received control instruction. It is thus possible to automatically perform management with respect to quality abnormalities, based on the quality measurement results measured by the measurement device 2.

Go back to the sequence view. Through the processing in the trouble processing section 1e, the management support apparatus 1 receives the trigger information notification from the management necessity determining section 1b in step S105, extracts the determination criteria information recorded in the management criteria database 12c in the information recording section 1a (S112), further receives the quality abnormality information from the management method determining section 1c in step S108 and detects the presence or absence of troubles that may cause quality abnormalities, based on the trigger information notification, determination criteria information and quality abnormality information (S113).

In step S113, the three trigger information notifications exemplified in FIG. 8 are compared with the recorded contents of the management criteria database 12c exemplified in FIG. 5, and, if a quality abnormality condition and a trouble condition are satisfied, a determination is made that a trouble that may cause an abnormality in the communication quality has occurred. For example, the measurement result of a record indicated at the top in FIG. 8 for the measurement device “Router 0001”—measurement package “Package 0001”—measurement port “Port 0001”, the service type “VoIP” and the measurement type “delay” is “3000 msec”. A management criterion to be compared with this record is the record shown at the top in FIG. 5 that matches the measurement device, measurement package, measurement port, service type, and measurement type. In this record, since the quality abnormality condition is “more than 500 msec”, a determination is made that an abnormality has occurred in the communication quality, based on the comparison in the quality abnormality conditions and the measurement result. Further, in the top record in FIG. 5, since Trouble Condition is “plural port abnormalities”, the management support apparatus 1 additionally detects whether or not an abnormality in the measurement port has occurred in other services, namely, services other than VoIP, such as stream. If a determination is made that an abnormality in the measurement port has occurred in other service, the management support apparatus 1 determines that a trouble that may cause a quality abnormality has occurred. In step S113, if a determination is made that no trouble has occurred, the following processes are not performed.

Go back to the sequence view. When the management support apparatus 1 determines that a trouble has occurred, it generates trouble information for notifying the trouble and outputs the generated trouble information from the output means 15 through the processing in the trouble processing section 1e (S114). Regarding output of the trouble information, in addition to output from the output means 15 that is a monitor, it is possible to develop various output methods, such as an output process for outputting the trouble information from the connecting means 16 to other device through the communication network 100.

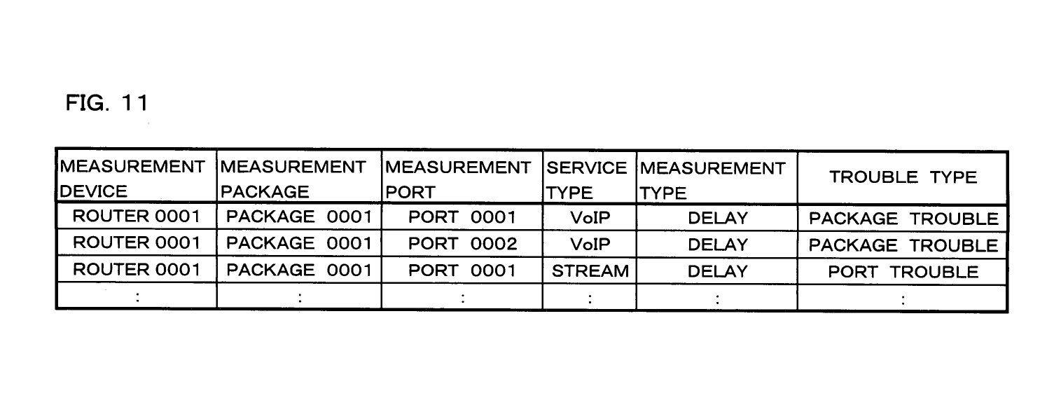

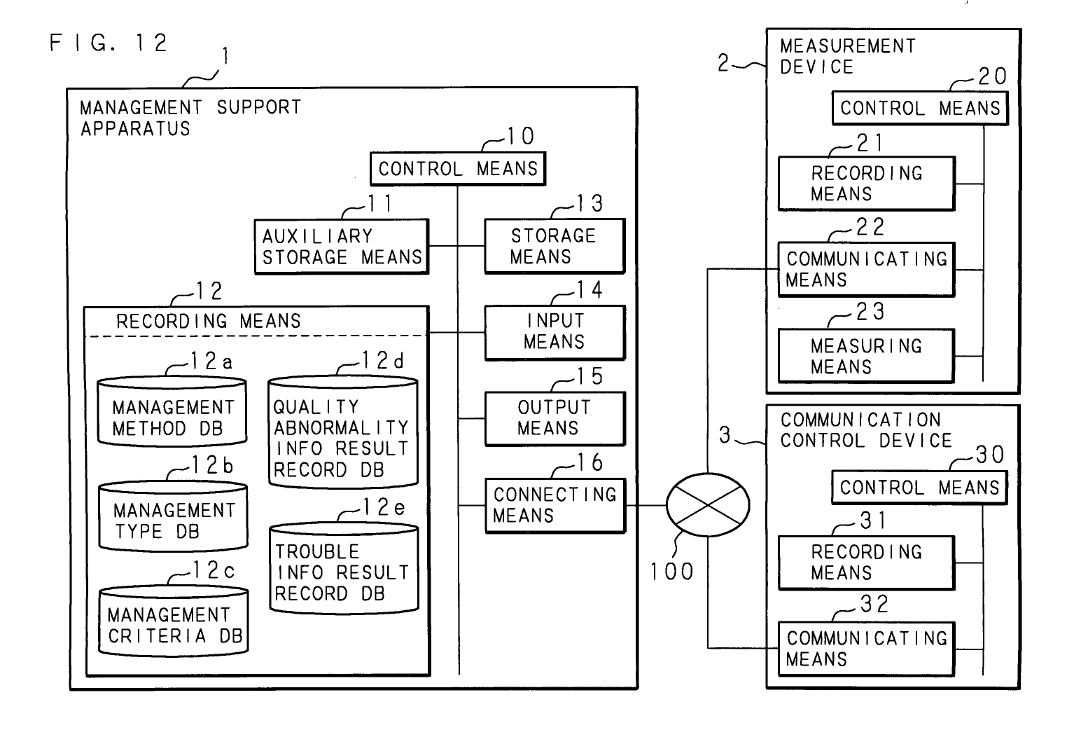

FIG.; 11 is an explanatory view showing trouble information in the management support apparatus 1 according to Embodiment 1 of the invention. The trouble information is information generated based on the trigger information notification, determination criteria information and quality abnormality information when a determination is made that a trouble that may cause a quality abnormality has occurred, and includes information indicating a measurement device, measurement package, measurement port, service type, measurement type, and trouble type. For example, the trouble information exemplified at the top in FIG. 11 indicates that the trouble “package trouble” occurred in the service “VoIP” provided by the measurement device “Router 0001”—measurement package “Package 0001”—measurement port “Port 0001”, and that this trouble caused the quality abnormality “delay”.

When the person in charge has confirmed the trouble information, he or she performs a restoring operation to solve the trouble concerning the outputted trouble information. It is thus possible to automatically detect troubles based on the quality measurement results measured by the measurement device 2.

Thus, in Embodiment 1, a quality abnormality concerning the communication network 100 is automatically detected based on one or a plurality of quality measurement results, without depending on the technique or knowledge of the person in charge, and the communication control device 3 is controlled based on the detection result. It is therefore possible to shorten the time required for a series of operations from collecting information to management,, and realize improved services. Moreover, it is possible to automatically detect troubles, promptly notify troubles and manage the troubles.

### Embodiment 2

Embodiment 2 is a mode according to Embodiment 1, and manages abnormalities in the communication quality by additionally taking into account the past results. Since the structure of a management support system according to Embodiment 2 is the same as in Embodiment 1, the explanation thereof is omitted by referring to Embodiment 1.

FIG. 12 is a block diagram showing the structure of a management support apparatus according to Embodiment 2 of the invention. In the following explanation, the components similar to those in Embodiment 1 will be designated with the same codes as in Embodiment 1, and the explanation thereof is omitted by referring to Embodiment 1. In the recording means 12 of the management support apparatus 1, the management method database 12a, management type database 12b, management criteria database 12c, quality abnormality information result record database 12d, and trouble information result record database 12e are formed as databases to be managed in the information recording section la. Note that the quality abnormality information result record database 12d and the trouble information result record database 12e are not necessarily formed in the recording means 12 of the management support apparatus 1, and may be formed in recording means of other device if they can be managed by the information recording section la. The information to be recorded in these databases are received by some method, such as reading from an information recording medium by the auxiliary storage means 11, receiving an operation from the input means 14, and reception through the connecting means 16.

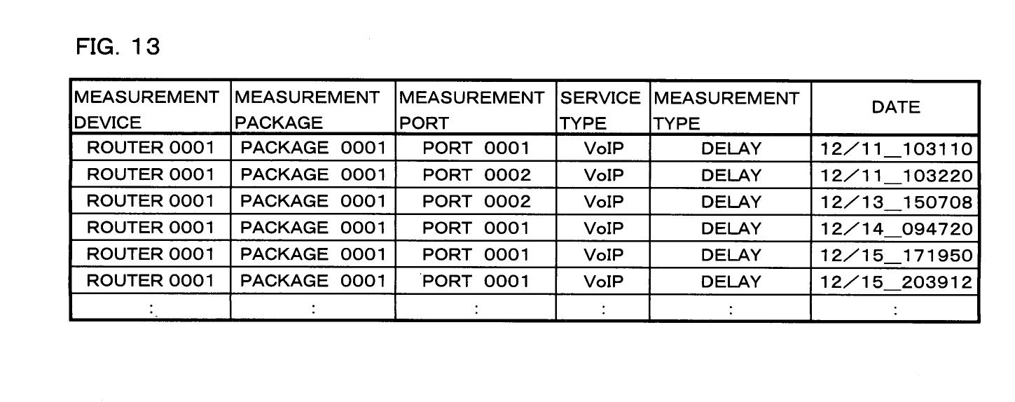

FIG. 13 is an explanatory view conceptually showing the recorded contents of the quality abnormality information result record database 12d in the management support apparatus 1 according to Embodiment 2 of the invention. The quality abnormality information result record database 12d is a database for recording the quality abnormality information explained in Embodiment 1 in association with dates. Thus, in the quality abnormality information result record database 12d, information indicating a date, such as “12/11_{—}103110” is recorded in association with information indicating a measurement device, measurement package, measurement port, service type and measurement type as the contents of the quality abnormality information. As the information indicating dates, it may be possible to use, for example, information indicating a date at which the quality abnormality information was generated,, and a date at which the quality abnormality information was recorded in the quality abnormality information result record database 12d.

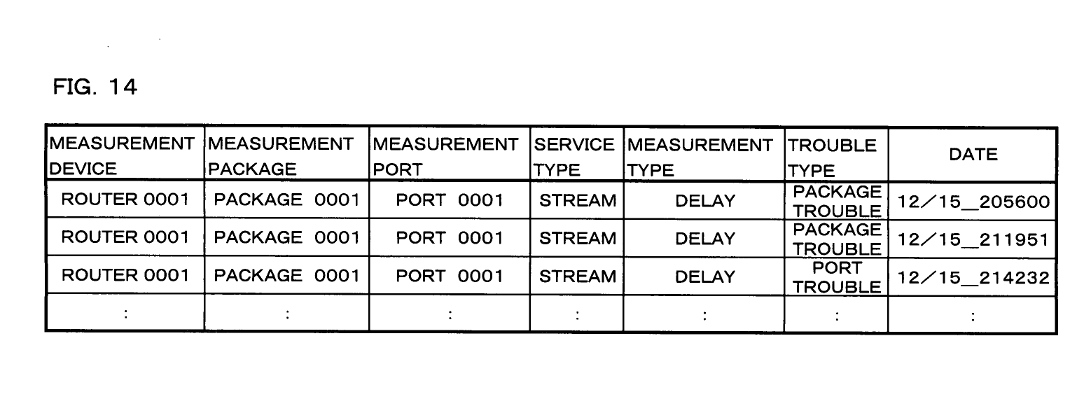

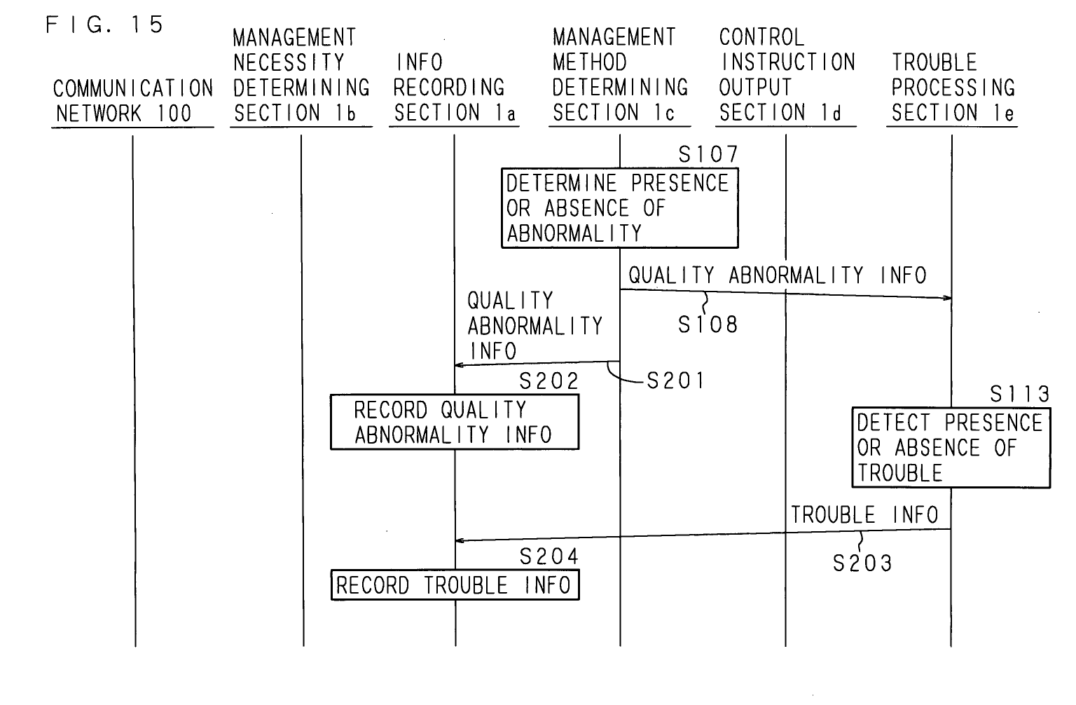

FIG. 14 is an explanatory view conceptually showing the recorded contents of the trouble information result record database 12e in the management support apparatus 1 according to Embodiment 2 of the invention. The trouble information result record database 12e is a database for recording the trouble information explained in Embodiment 1 in association with dates. Thus, in the trouble information result record database 12e, information indicating a date, such, as “12/15_{—}205600” is recorded in association with the information indicating a measurement device, measurement package, measurement port, service type, measurement type, and trouble type as the contents of the trouble information. As the information indicating a date, it may be possible to use, for example, information indicating a date at which the trouble information was generated, and a date at which the trouble information was recorded in the trouble information result record database 12e.

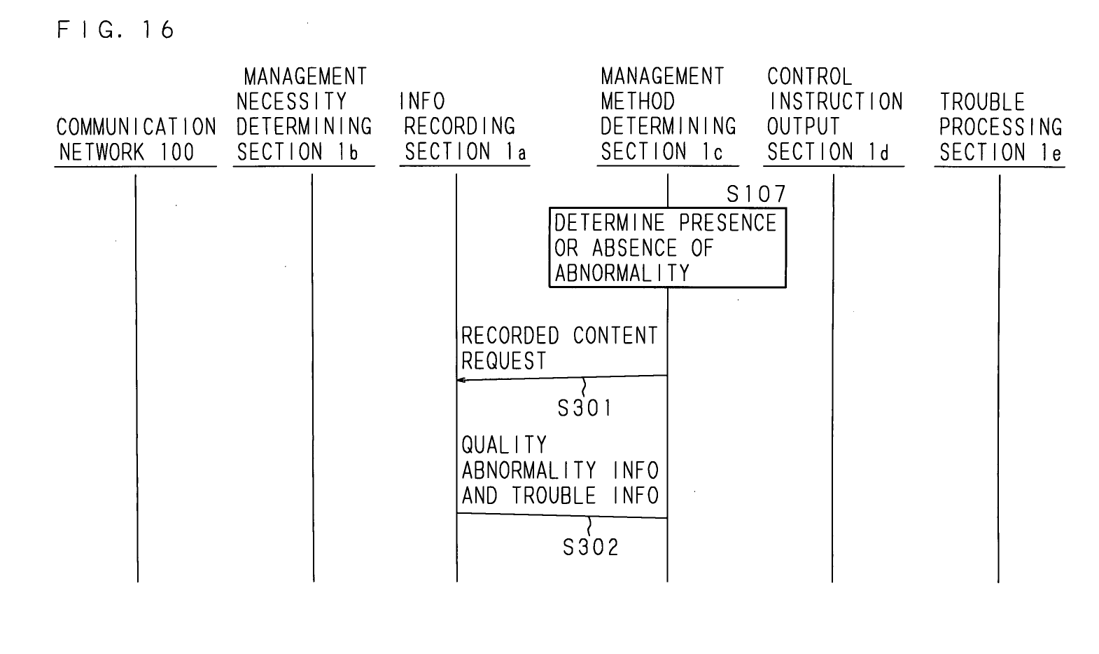

FIG. 15 is a sequence view showing a result recording process performed in the management support apparatus 1 according to Embodiment 2 of the invention. Regarding the processes explained in Embodiment 1, the detailed explanation is omitted by referring to Embodiment 1. Moreover, the same processes as in Embodiment 1 will be explained by designating the same step numbers. The management support apparatus 1 executes the processes of steps S101 to S107 explained in Embodiment, and determines whether or not an abnormality has occurred in the communication quality (S107). When a determination is made that an abnormality has occurred in the communication quality, the management support apparatus 1 sends the quality abnormality information to the trouble processing section 1e through the processing in the management method determining section 1c (S108), and further sends the quality abnormality information to the information recording section 1a (S201).

Through the processing in the information recording section 1a, the management support apparatus 1 adds information indicating a date to the quality abnormality information received from the management method determining section 1c, and records the information in the quality abnormality information result record database 12d (S202).

Moreover, through the processing in the trouble processing section 1e, the management support apparatus 1 detects whether or not a trouble that may cause a quality abnormality has occurred, based on the information such as quality abnormality information received from the management method determining section 1c (S113), and generates trouble information and sends it to the information recording section 1a if a determination is made that the trouble has occurred (S203).

Through the processing in the information recording section 1a, the management support apparatus 1 adds information indicating a date to the trouble information received from the trouble processing section 1e, and records the information in the trouble information result record database 12e (S204).

In this manner, the management support apparatus 1 according to Embodiment 2 of the present invention records the results of generation of quality abnormality information and trouble information.

FIG. 16 is a sequence view conceptually showing a quality abnormality detecting process performed in the management support apparatus 1 according to Embodiment 2 of the invention. Through the-processing in the management method determining section 1c, the management support apparatus 1 determines whether or not an abnormality has occurred in the communication quality in step S107, and sends a recorded content request for requesting the recorded contents of the past quality abnormality information and trouble information to the information recording section 1a if a determination is made that a trouble has occurred in the communication quality (S301).

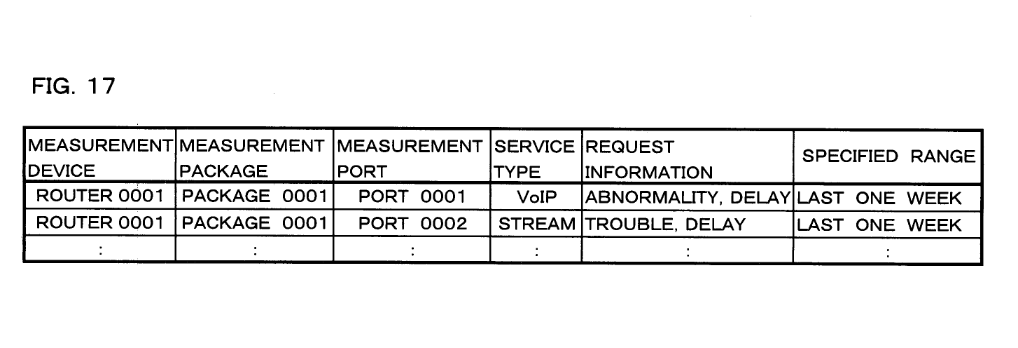

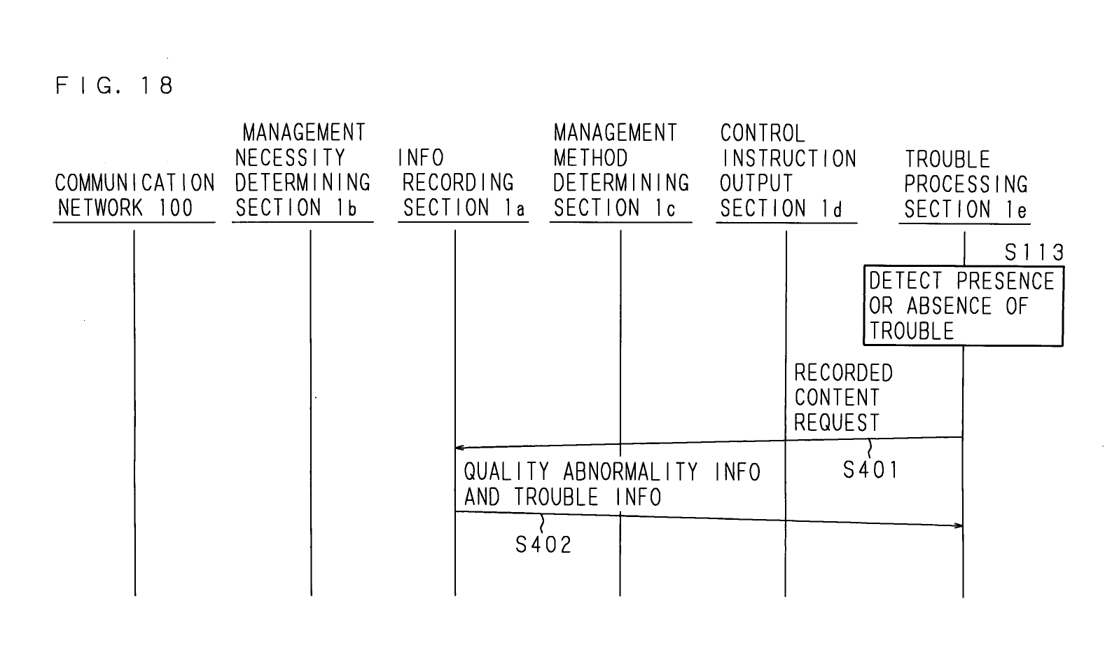

FIG. 17 is an explanatory view conceptually showing a recorded content request in the management support apparatus 1 according to Embodiment 2 of the invention. The recorded content request is an instruction showing the conditions for extracting information from the quality abnormality information result record database 12d and the trouble information result record database 12e, and includes extraction conditions indicating a measurement device, measurement package, measurement port, service type, request information and specified range as shown in FIG. 17. The request information is information specifying a database and a measurement type for extracting information, such as “abnormality, delay” and “trouble, delay”. The specified range is information that specifies a period, such as “the last one week” and “the last one year”. For example, the request information shown at the top is an instruction to extract a record corresponding to the measurement device “Router 0001”, measurement package “0001”, measurement port “0001”, service type “VoIP”, measurement type “delay”, and a date within the last one week among the records recorded in the quality abnormality information result record database 12d.

Go back to the sequence view. Through the processing in the information recording section 1a, the management support apparatus 1 receives the recorded content request from the management, method determining section 1c, extracts the quality abnormality information from the quality abnormality information result record database 12d, based on the received recorded content request, extracts the trouble information from the trouble information result record database 12e, and sends the extracted quality abnormality information and trouble information to the management method determining section 1c (S302).

The management method determining section 1c determines a management method by additionally taking into account the received past quality abnormality information and trouble information, and performs management with respect to the abnormality as explained in Embodiment 1 by sending a control request based on the determined management method to the control instruction output section 1d. The determination of a management method by taking into account additionally the past quality abnormality information and trouble, information is realized by recording the management method information showing the past results as conditions in the management method database 12a.

FIG. 18 is a sequence view showing a trouble detecting process performed in the management support apparatus 1 according to Embodiment 2 of the invention. Through the processing in the trouble processing section 1e, the management support apparatus 1 detects whether or not a trouble has occurred in step S113, and sends a recorded content request for requesting the recorded contents of the past quality abnormality information and trouble information to the information recording section 1a if a trouble is detected (S401). The recorded content request sent to the information recording section 1a in step S401 is the same as the recorded content request explained using FIG. 17.

Through the processing in the information recording section 1a, the management support apparatus 1 receives the recorded content request from the trouble processing section 1e, extracts the quality abnormality information from the quality abnormality information result record database 12d based on the received recorded content request, extracts the trouble information from the trouble information result record database 12e, and sends the extracted quality abnormality information and trouble information to the trouble processing section 1e (S402).

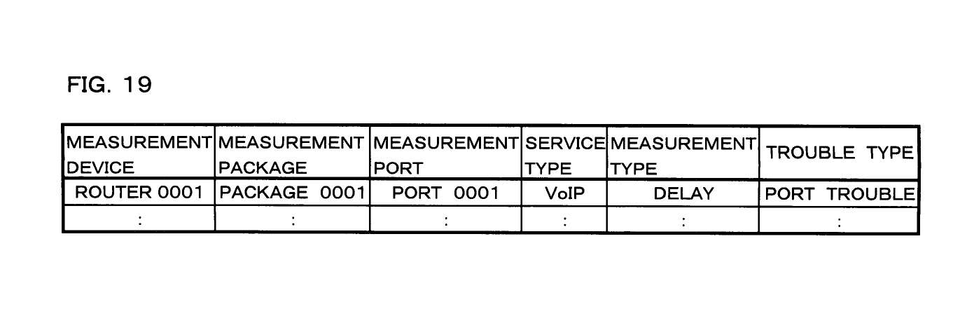

FIG. 19 is an explanatory view conceptually showing the trouble information in the management support apparatus 1 according to Embodiment 2 of the invention. FIG. 19 shows trouble information to be sent from the information recording section 1a to the trouble processing section 1e in step S402, and trouble information indicating the measurement device “Router 0001”—measurement package “Package 0001”—measurement port “Port 0001”, the service type “stream”, the measurement type “delay”, and the trouble type “port trouble” is extracted. The trouble information shown in FIG. 19 is trouble information extracted when the information shown at the top in the quality abnormality information exemplified in FIG. 9 of Embodiment 1 and the records shown from the top to the fifth line in the quality abnormality information result record database 12d exemplified in FIG. 13 satisfy the trouble conditions in the management criteria database 12c exemplified in FIG. 5 of Embodiment 1. Thus, in the management method determining section 1c, trouble information is extracted by additionally taking into account the received past quality abnormality information and trouble information, and the trouble information is outputted.

Thus, in Embodiment 2, it is possible to automatically detect quality abnormalities by additionally taking into account the past results and automatically detect troubles, without depending on the technique or knowledge of the person in charge.

### Embodiment 3

Embodiment 3 is a mode according to Embodiment 1, and controls the communication control device 3, based on the contents of a detected trouble. Since the structure of a management support system and the structure of a management support apparatus according to Embodiment 3 are the same as in Embodiment 1, the explanation thereof is omitted by referring to Embodiment 1. In the following explanation, the components similar to those in Embodiment 1 will be designated with the same codes as in Embodiment 1, and the explanation thereof is omitted by referring to Embodiment 1.

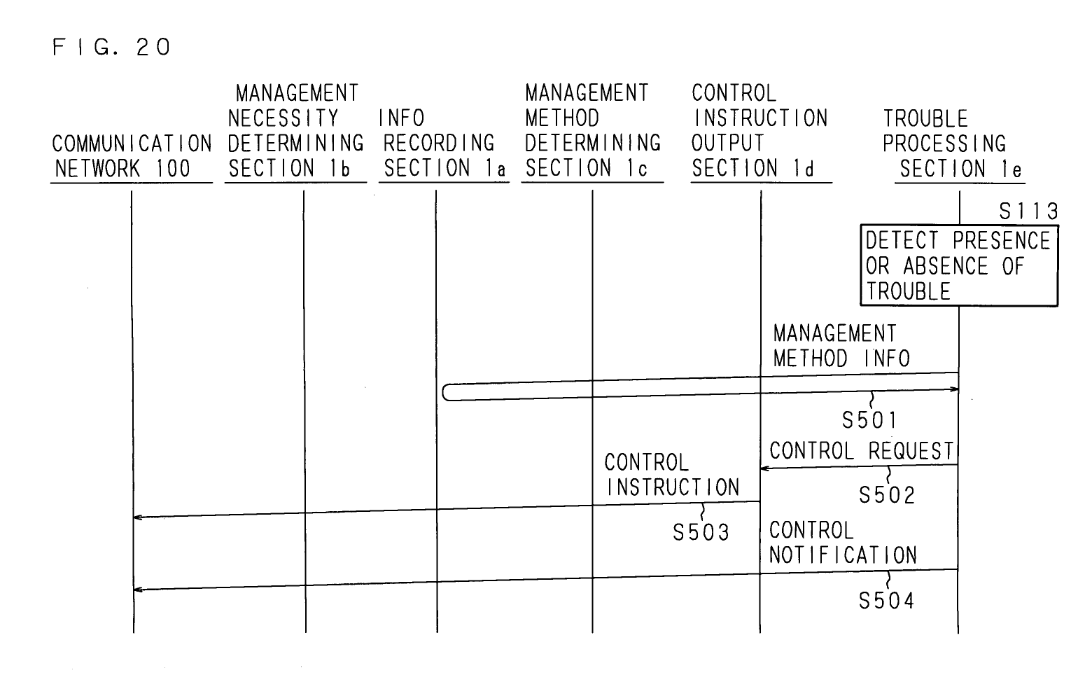

FIG. 20 is a sequence view showing a trouble detecting process performed in the management support apparatus 1 according to Embodiment 3 of the invention. Regarding the processes explained in Embodiment 1, the detailed explanation is omitted by referring to Embodiment 1. Moreover, the same processes as in Embodiment 1 will be explained by designating the same step numbers. The management support apparatus 1 executes the processes of steps S101 to S113 explained in Embodiment 1 to detect whether or not an abnormality has occurred (S113).

Through the processing in the trouble processing section 1e, the management support apparatus 1 generates trouble information based on the trigger information notification, determination criteria information and quality abnormality information and extracts the management method information from the management method database 12a in the information recording section 1a, based on the generated trouble information (S501), and sends a control request determined based on the extracted management method information to the control instruction output section 1d (S502). The control instruction output section 1d transmits a control instruction based on the received control request to the communication control device 3 to be controlled over the communication network 100 (S503).

The trouble information in step S501 is similar to the trouble information explained in Embodiment 1 using FIG. 11. The management method information in step S501 is similar to the management method information recorded in the management method database 12a explained in Embodiment 1 using FIG. 3. The control request in step S502 and the control instruction in step S503 are the same as the control request explained in Embodiment 1 using FIG. 10.

Go back to the sequence view. Through the processing in the trouble processing section 1e, the management support apparatus 1 generates a control notification indicating the status of the trouble and the contents of the control, based on the trigger information notification, determination criteria information, quality abnormality information and control instruction, and outputs the generated control notification from the output means 15 (S504).

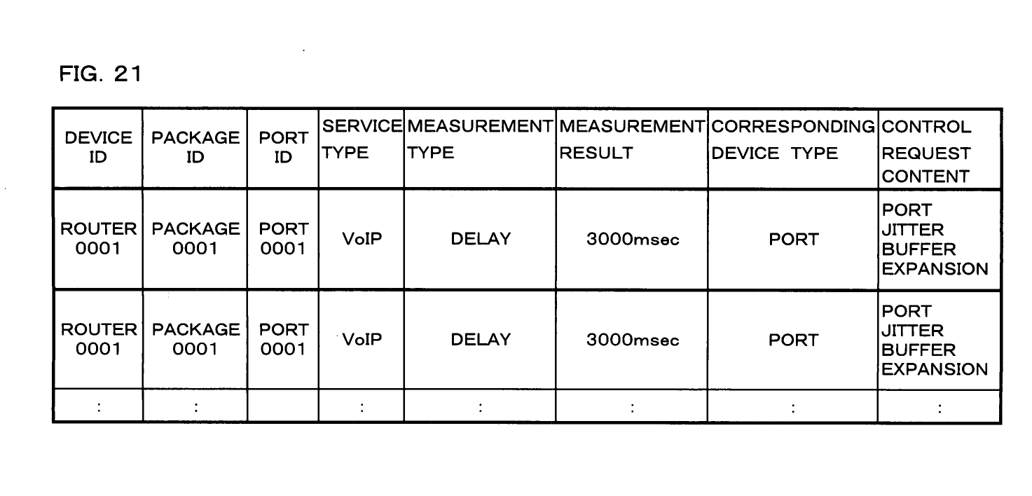

FIG. 21 is an explanatory view showing the control notification in the management support apparatus 1 according to Embodiment 3 of the invention. The control notification shows the device ID, package ID and port ID indicating a place where the trouble has occurred, the service type in which the trouble has occurred, the measurement type and measurement result indicating the contents of the trouble, the corresponding device type, and the control request content showing the content of management with respect to the trouble. FIG. 21 shows that the control “port jitter buffer expansion” was performed on the place where the package ID is “Package 0001” and the port ID is “Port 0001” in the communication control device 3 with the device ID “Router 0001”.

Thus, in Embodiment 3, without depending on the technique or knowledge of the person in charge, it is possible to automatically detect troubles, control the communication control device 3 based on the detection results, and notify the contents.

### Embodiment 4

Embodiment 4 is a mode according to Embodiment 1 and detects troubles by additionally taking into account the structure of the communication network. Since the structure of a management support system according to Embodiment 4 is the same as in Embodiment 1, the explanation thereof is omitted by referring to Embodiment 1.

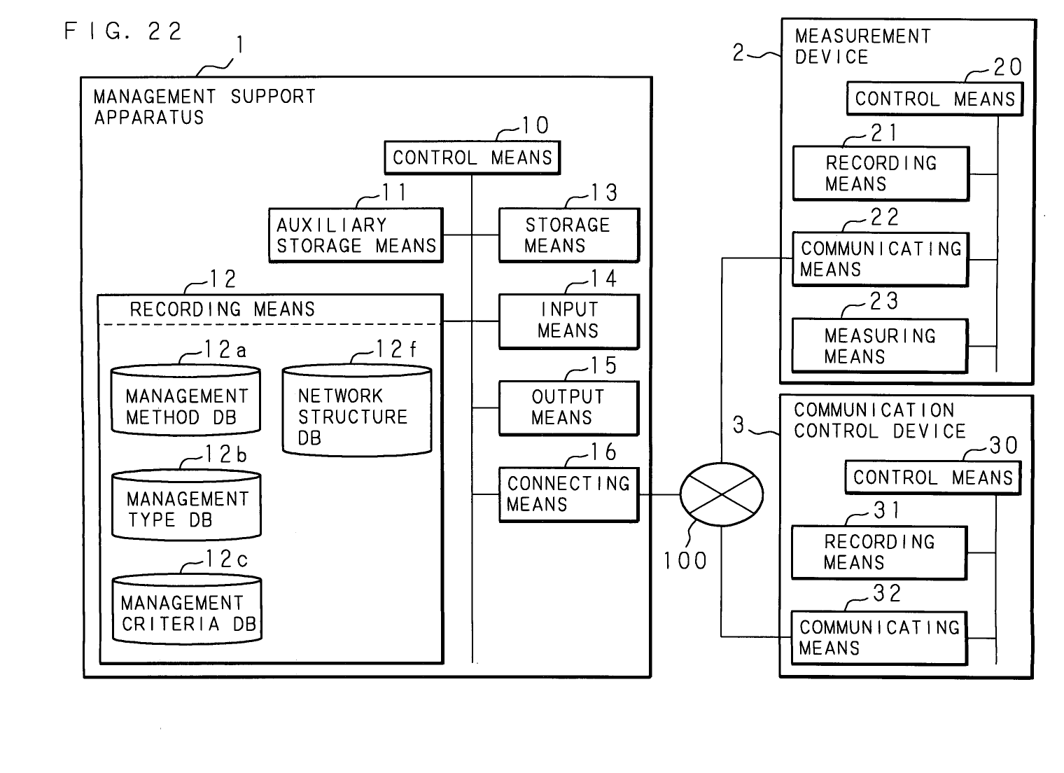

FIG. 22 is a block diagram showing the structure of a management support apparatus according to Embodiment 4 of the invention. In the following explanation, the components similar to those in Embodiment 1 will be designated with the same codes as in Embodiment 1, and the explanation thereof is omitted by referring to Embodiment 1. In the recording means 12 of the management support apparatus 1, the management method database 12a, management type database 12b, management criteria database 12c, and network structure database 12f are formed as databases to be managed in the information recording section 1a. Note that the network structure database 12f is not necessarily formed in the recording means 12 of the management support apparatus 1, and may be formed in recording means of other device if it can be managed by the information recording section 1a. The information to be recorded in these databases are received by some method, such as reading from an information recording medium by the auxiliary storage means 11, receiving an operation from the input means 14, and reception through the connecting means 16.

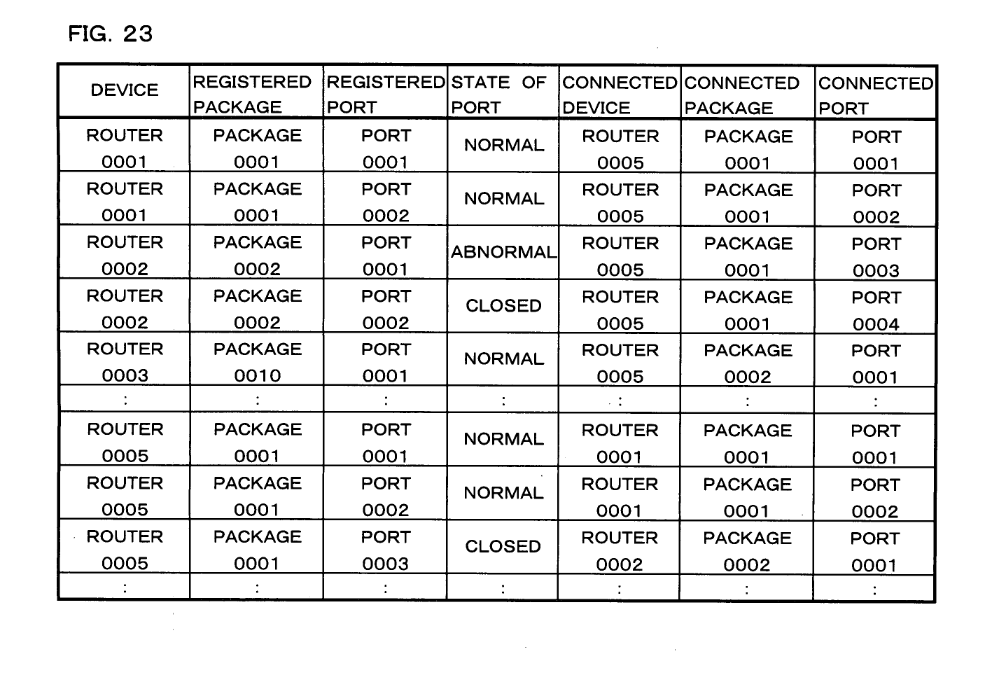

FIG. 23 is an explanatory view conceptually showing the recorded contents of the network structure database 12f in the management support apparatus 1 according to Embodiment 4 of the invention. In the network structure database 12f, various kinds of information about a record that associates items such as a device (communication network device), registered package, registered port, port state, connected device, connected package, and connected port with each other are recorded as network structure information indicating the devices constituting the communication network 100 and the status thereof. In the Device field, information such as “Router 0001” constituting the communication network 100 is recorded. In the Registered Package field, information such as “Package 0001” indicating-a package registered for the device is recorded. In the Registered Port field, information such as “Port 0001” indicating a port registered for the device is recorded. In the Port State field, information such as “normal”, “abnormal”, and “closed” indicating the state of the registered port is recorded. In the Connected Device field, information such as “Router 0005” indicating a device (communication network device) connected to this apparatus is recorded. In the Connected Package field, information indicating a package included in the connected device and connected to the device shown in the Device field, such as “Package 0001”, is recorded. In the Connected Port field, information indicating a port provided in the connected device and connected to the device shown in the Device field, such as “Port 0001”, is recorded.

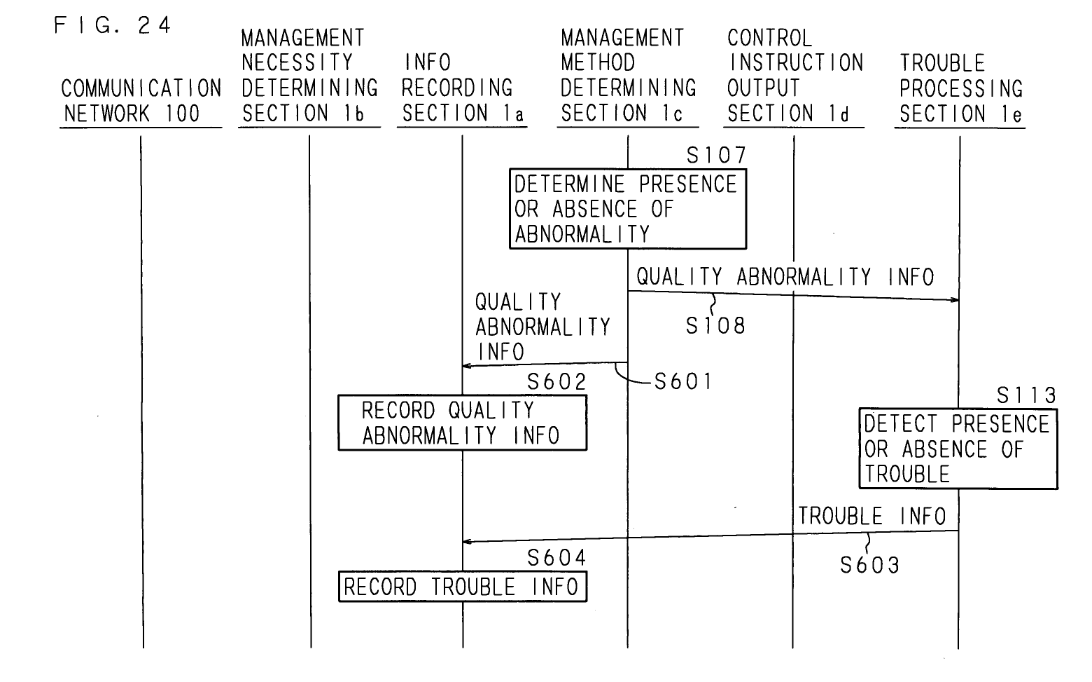

FIG. 24 is a sequence view showing a result recording process performed in the management support apparatus 1 according to Embodiment 4 of the invention. Regarding the processes explained in Embodiment 1, the detailed explanation is omitted by referring to Embodiment 1. Moreover, the same processes as in Embodiment 1 will be explained by designating the same step numbers. The management support apparatus 1 executes the processes of steps S101 to S107 explained in Embodiment 1, and determines whether or not an abnormality has occurred in the communication quality (S107). When a determination is made that an abnormality has occurred in the communication quality, the management support apparatus 1 sends the quality abnormality information to the trouble processing section 1e through the processing in the management method determining section 1c (S108); and further sends the quality abnormality information to the information recording section la (S601).

Through the processing in the information recording section 1a, the management support apparatus 1 records the quality abnormality information received from the management method determining section 1c in the recording means 12 in association with the recorded contents of the network structure database 12f (S602).

The quality abnormality information recorded in the recording means 12 in step S602 is the quality abnormality information explained in Embodiment 1 using FIG. 9. By using the measurement device, measurement package and measurement port as key information, the quality abnormality information is recorded in association with a record where information shown in the fields of Device, Registered Package, and Registered Port in the network structure database 12f is the same as the key information. Note that the quality abnormality information may be formed in recording means of other device if it is managed in the information recording section la. It may also be possible to associate the quality abnormality information to be recorded in the quality abnormality information result record database 12d explained in Embodiment 2 with the recorded contents of the network structure database 12f.

Through the processing in the trouble processing section 1e, the management support apparatus 1 detects whether or not a trouble that may cause a quality abnormality has occurred, based on the information such as quality abnormality information received from the management method determining section 1c (S113), and generates trouble information and sends it to the information recording section 1a if a determination is made that the trouble has occurred (S603).

Through the processing in the information recording section 1a, the management support apparatus 1 records the trouble information received from the trouble processing section 1e in the recording means 12 in association with the recorded contents of the network structure database 12f (S604).

The trouble information recorded in the recording means 12 in step S604 is the trouble information explained in Embodiment 1 using FIG. 11. By using the measurement device, measurement package and measurement port as key information, the trouble information is recorded in association with a record where information shown in the fields of Device, Registered Package, and Registered Port in the network structure database 12f is the same as the key information. Note that the trouble information may be recorded in recording means of other device if it is managed in the information recording section 1a. It may also be possible to associate the trouble information to be recorded in the trouble information result record database 12e explained in Embodiment 2 with the recorded contents of the network structure database 12f.

In this manner, the management support apparatus 1 according to Embodiment 4 of the present invention records the quality abnormality information and trouble information in association with the network structure database 12f.

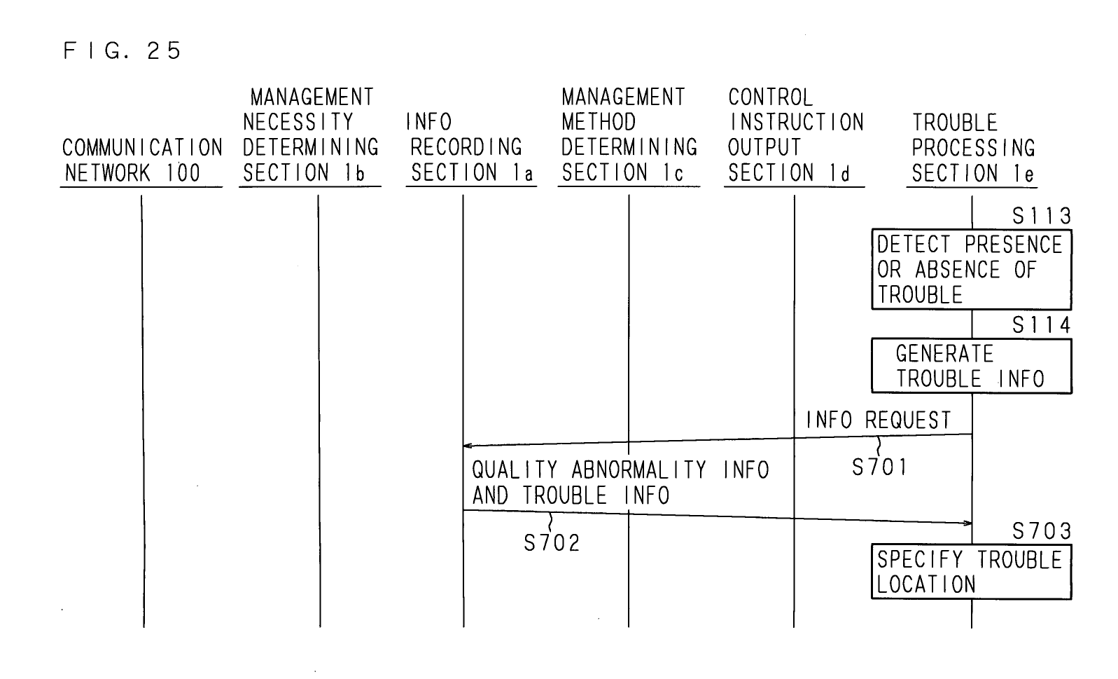

FIG. 25 is a sequence view showing the trouble detecting process performed in the management support apparatus 1 according to Embodiment 4 of the invention. As explained in Embodiment 1, through the processing in the trouble processing section 1e, the management support apparatus 1 detects the presence or absence of troubles that may cause quality abnormalities, based on the trigger information notification received from the management necessity determining section 1b, the quality abnormality information received from the management method determining section 1c, and the determination criteria information extracted from the management criteria database 12c (S113), and generates the trouble information (S114).

Through the processing in the trouble processing section 1e, the management support apparatus 1 sends an information request for requesting the quality abnormality information and trouble information associated with the network structure information recorded in the network structure database 12f to the information recording section 1a (S701).

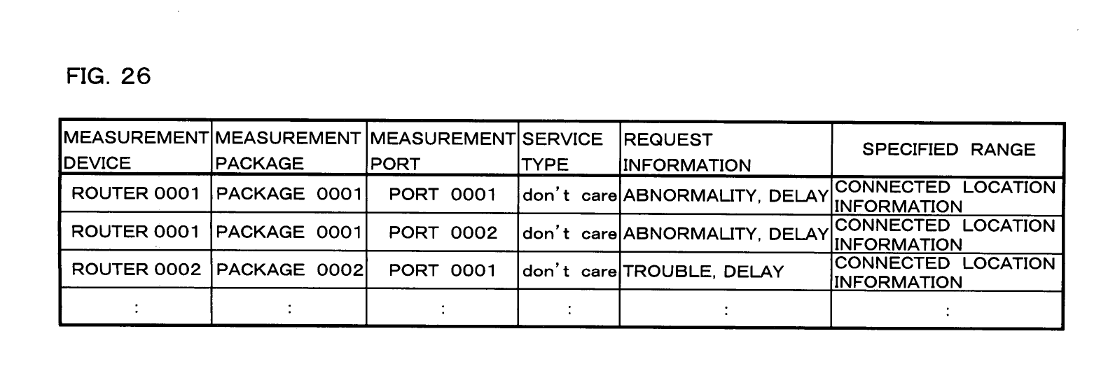

FIG. 26 is an explanatory view conceptually showing the information request in the management support apparatus 1 according to Embodiment 4 of the invention. The information request is an instruction indicating the conditions for extracting the quality abnormality information and trouble information associated with the network structure information, and includes the extraction conditions indicating a measurement device, measurement package, measurement port, service type, request information, and a specified range. “don't care” shown in the Service Type field means that all service information is specified. The request information is information for specifying a type of information to be extracted and a measurement type, such as “abnormal, delay” and “trouble, delay”. The specified range is information, such as “connected location information”, indicating a range of information to be extracted from the network structure information associated with the network structure database 12f. For example, when the specified range is “connected location information”, information indicating the “connected device, “connected package”, and “connected port” is extracted from the network structure information recorded in the network structure database 12f.

Go back to the sequence view. Through the processing in the information recording section 1a, the management support apparatus 1 receives the information request from the trouble processing section 1e, extracts the quality abnormality information and trouble information associated with the network structure information based on the received information request, and sends the extracted quality abnormality information and trouble information to the trouble processing section 1e (S702).

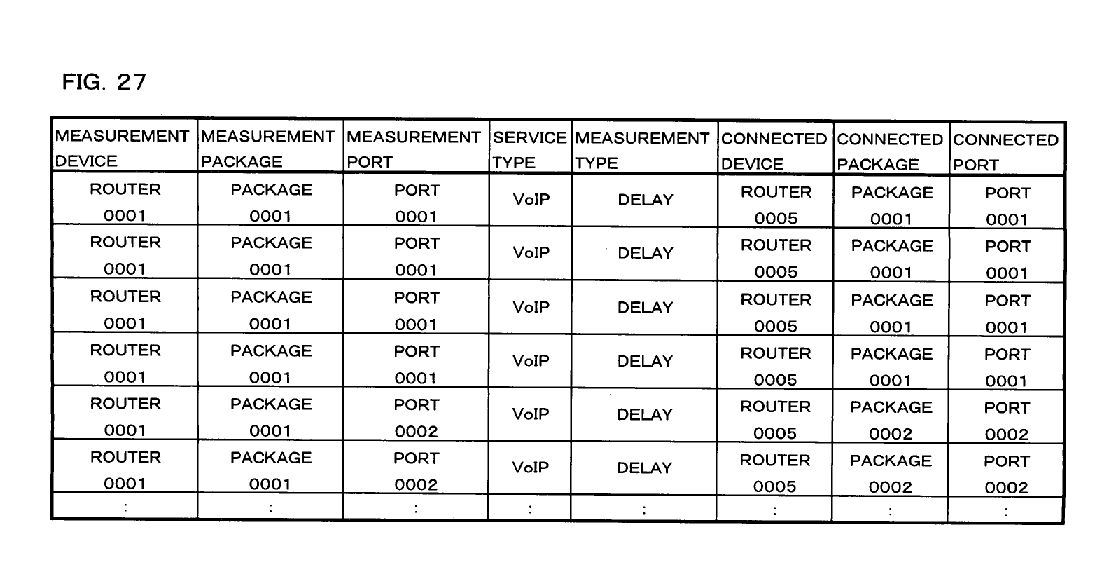

FIG. 27 is an explanatory view conceptually showing the quality abnormality information associated with the network structure information in the management support apparatus 1 according to Embodiment 4 of the invention. As shown in FIG. 27, in the quality abnormality information associated with the network structure information, information indicating a connected device, connected package, and connected port which are the items of the network structure information is associated with information indicating a measurement device, measurement package, measurement port, service type, and measurement type which are the items of the original quality abnormality information.

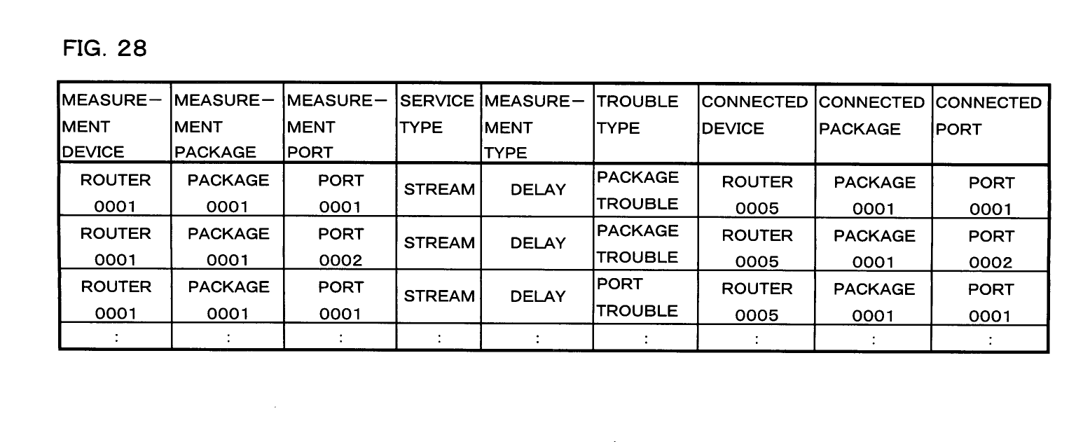

FIG. 28 is an explanatory view conceptually showing the trouble information associated with the network structure information in the management support apparatus 1 according to Embodiment 4 of the invention. As shown in FIG. 28, in the trouble information associated with the network structure information, information indicating a connected device, connected package and connected port which are the items of the network structure information is associated with information indicating a measurement device, measurement package, measurement port, service type, measurement type and trouble type which are the items of the original trouble information.

Go back to the sequence view. Through the processing in the trouble processing section 1e, the management support apparatus 1 specifies a trouble location from the quality abnormality information and trouble information in step S114, and the quality abnormality information and trouble information associated with the network structure information received in step S702. (S703).

In step S114, the trouble information shown in FIG. 11 of Embodiment 1 is generated. The management support apparatus 1 detects from the trouble information and the quality abnormality information shown in FIG. 9 of Embodiment 1 that a quality abnormality and a trouble have occurred in the measurement device “Router 0001”—measurement package “Package 0001”—measurement port “Port 0001”, and the measurement device “Router 0001”—measurement package “Package 0001”—measurement port “0002”. It is also possible to detect from the quality abnormality information and trouble information associated with the network structure information shown in FIGS. 27 and 28 that the connected location common to them is the connected device “Router 0005”—connected package “Package 0001”—connected port “Port 0001”, and the connected device “Router 0005”—connected package “Package 0001”—connected port “Port 0002”. Accordingly, in step S703, it is possible to specify that the trouble location is the measurement device “Router 0001”—measurement package “Package 0001”.

Thus, in Embodiment 4, it is possible to detect a trouble by additionally taking into account the structure of the communication network and specify the trouble location, without depending on the technique or knowledge of the person in charge.

### Embodiment 5

Embodiment 5 is a mode according to Embodiment 1, and detects a trouble based on packets transmitted and received over the communication network. Since the structure of a management support system according to Embodiment 5 is the same as in Embodiment 1, the explanation thereof is omitted by referring to Embodiment 1.

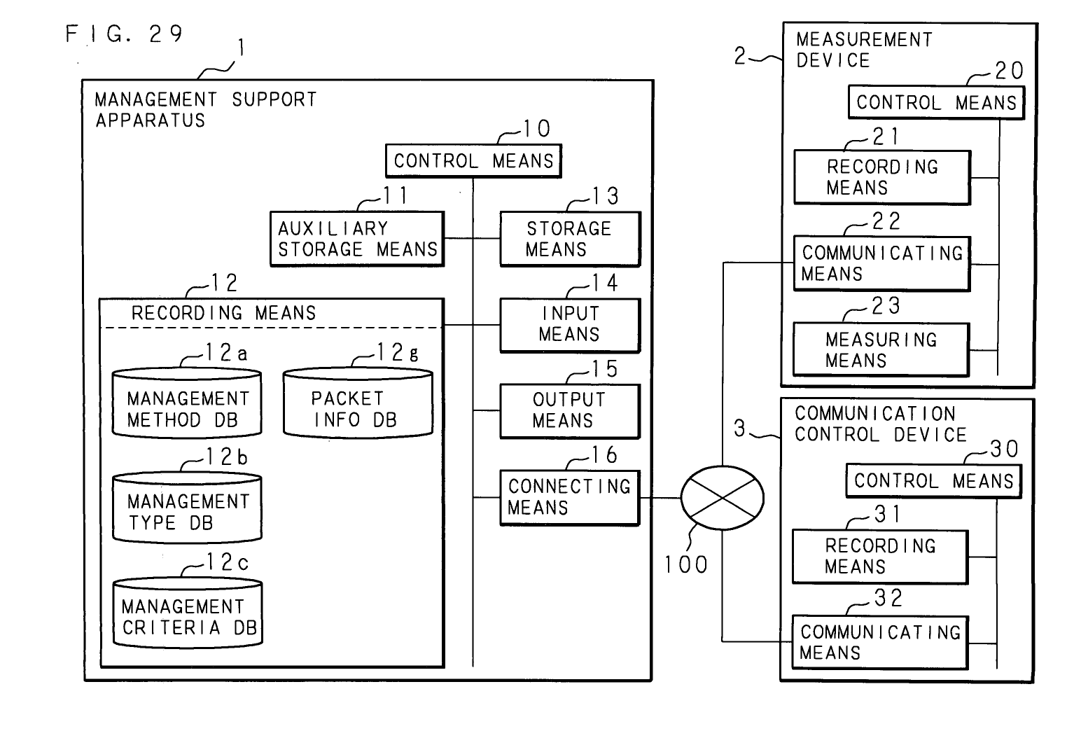

FIG. 29 is a block diagram showing the structure of a management support apparatus according to Embodiment 5 of the invention. In the following explanation, the structures similar to those in Embodiment 1 will be designated with the same codes as in Embodiment 1, and the explanation thereof is omitted by referring to Embodiment 1. In the recording means 12 of the management support apparatus 1, the management method database 12a, management type database 12b, management criteria database 12c, and packet information database 12g (attribute database) are formed as databases to be managed in the information recording section 1a. Note that the packet information database 12g is not necessarily formed in the recording means 12 of the management support apparatus 1, and may be formed in recording means of other device if it can be managed in the information recording section 1a. The information to be recorded in these databases is received by some method, such as reading from an information recording medium by the auxiliary storage means 11, receiving an operation from the input means 14, and reception through the connecting means 16.

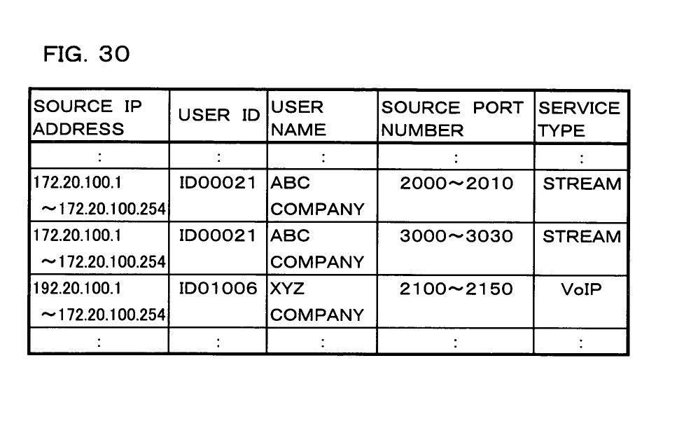

FIG. 30 is an explanatory view conceptually showing the recorded contents of the packet information database 12g in the management support apparatus 1 according to Embodiment 5 of the invention. In the packet information database 12g, various kinds of information about a record that associates items such as the source IP address, user ID, user name, source port number, and service type with each other are recorded as packet information about packets used in various services to be provided through the communication network 100. Recorded in the Source Address field is information such as “172.20.100.1 to 172.20.100.254” indicating the IP addresses of the source device shown by the header information of the packets. Recorded in the User ID field is information such as “ID00021” that is identification information assigned to the user. Recorded in the User Name field is information such as “ABC Company” indicating the user. Recorded in the Source Port Number field is information such as “2000 to 2010” indicating the port numbers of the source device of the packets.

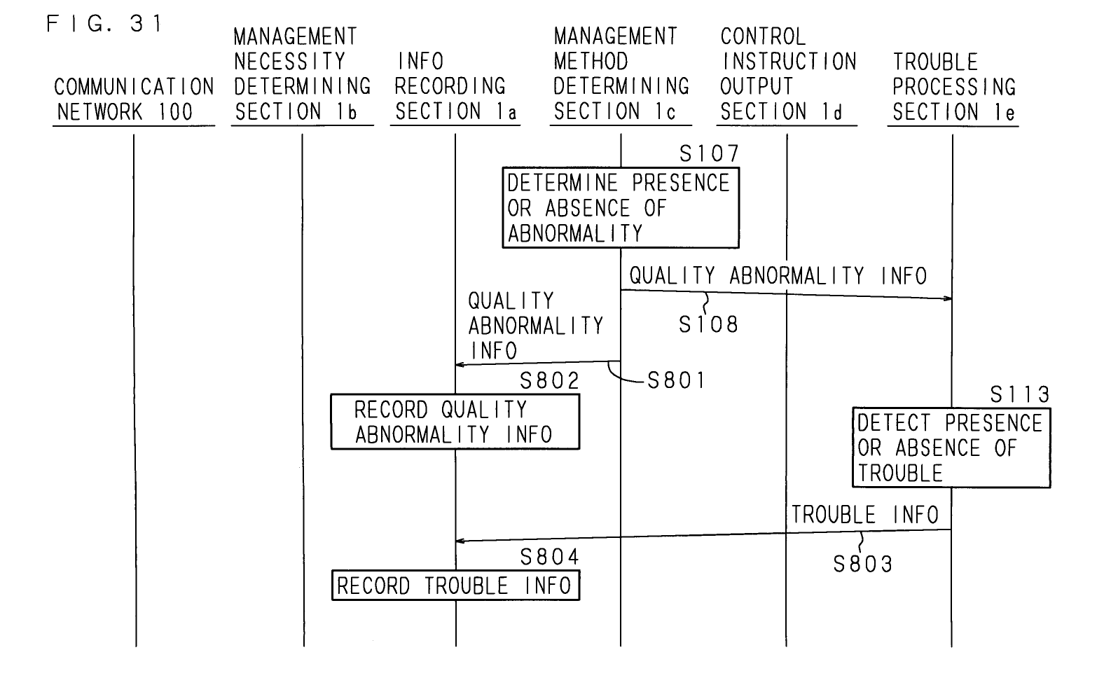

FIG. 31 is a sequence view showing the result recording process performed in the management support apparatus 1 according to Embodiment 5 of the invention. Regarding the processes explained in Embodiment 1, the detailed explanation is omitted by referring to Embodiment 1. Moreover, the same processes as in Embodiment 1 will be explained by designating the same step numbers. The management support apparatus 1 executes the processes of steps S101 to S107 explained in Embodiment 1 to determine whether or not an abnormality has occurred in the communication quality (S107). When a determination is made that an abnormality has occurred in the communication quality, the management support apparatus 1 sends the quality abnormality information to the trouble processing section 1e through the processing in the management method determining section 1c (S108), and further sends the quality abnormality information to the information recording section 1a (S801).

Through the processing in the information recording section 1a, the management support apparatus 1 records the quality abnormality information received from the management method determining section 1c in the recording means 12 in association with the packet information indicating the recorded contents of the packet information database 12g (S802).

The quality abnormality information to be recorded in the recording means 12 in step S802 is the quality abnormality information explained in Embodiment 1 using FIG. 9. In Embodiment 5, when a quality abnormality is detected, information about the source IP address, source port number, etc. indicated as the header information in the packets related to a communication service in which the abnormality has occurred is detected. Then, by using the detected source IP address and source port number as key information, the quality abnormality information is recorded in association with a record where information indicated in the fields of Source IP Address and Source Port Number in the packet information database 12g is the same as the key information. Note that the quality abnormality information may be recorded in recording means of other device if it is managed in the information recording section 1a.

Moreover, through the processing in the trouble processing section 1e, the management support apparatus 1 detects whether or not a trouble that may cause a quality abnormality has occurred, based on information such as the quality abnormality information received from the management method determining section 1c (S113), and generates trouble information and sends it to the information recording section 1a if a determination is made that the trouble has occurred (S803).

Through the processing in the information recording section 1a, the management support apparatus 1 records the trouble information received from the trouble processing section 1e in the recording means 12 in association with the recorded contents of the packet information database 12g (S804).

The trouble information to be recorded in the recording means 12 in step S804 is the trouble information explained in Embodiment 1 using FIG. 11. In Embodiment 5, when a trouble is detected, information such as the source IP address, source port number, etc. indicated as the header information in packets concerning a communication service in which the trouble has occurred is detected. Then, by using the detected source IP address and source port number as key information, the trouble information is recorded in association with a record where information indicated in the fields of Source IP Address and Source Port Number in the packet information database 12g is the same as the key information. Note that the trouble information may be recorded in recording means of other device if it is managed in the information recording section la.

In this manner, the management support apparatus 1 according to Embodiment 4 of the present invention records the quality abnormality information and trouble information in association with the packet information database 12g.

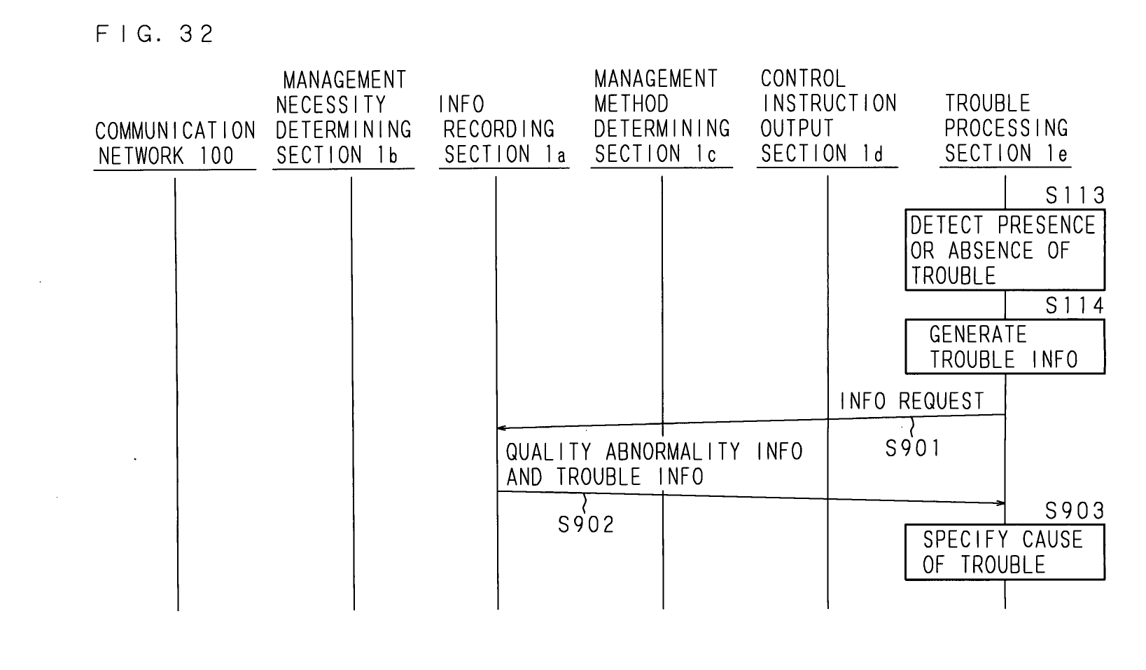

FIG. 32 is a sequence view showing a trouble detecting process performed in the management support apparatus 1 according to Embodiment 5 of the invention. Through the processing in the trouble processing section 1e, as explained in Embodiment 1, the management support apparatus 1 detects the presence or absence of troubles that may cause quality abnormalities, based on the trigger information notification received from the management necessity determining section 1b, the quality abnormality information received from the management method determining section 1c, and the determination criteria information extracted from the management criteria database 12c (S113), and generates trouble information (S114).

Then, through the processing in the trouble processing section 1e, the management support apparatus 1 sends an information request for requesting the quality abnormality information and trouble information associated with the packet information indicating the recorded contents of the packet information database 12g to the information recording section la (S901).

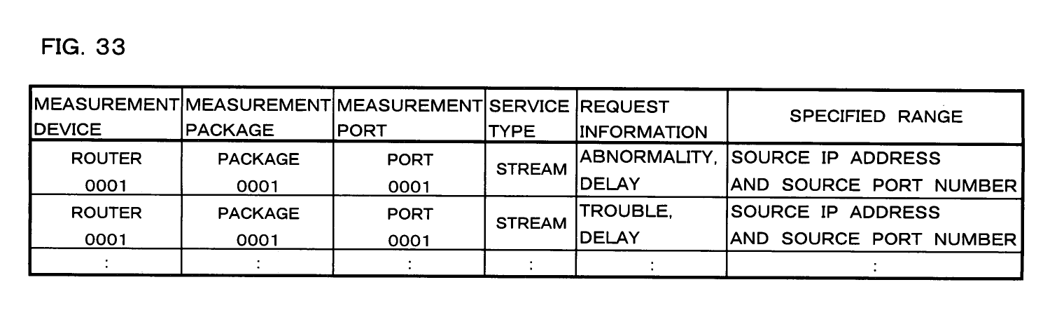

FIG. 33 is an explanatory view conceptually showing an information request in the management support apparatus 1 according to Embodiment 5 of the invention. The information request is an instruction indicating the conditions for extracting the quality abnormality information and trouble information associated with the recorded contents of the packet information database 12g, and includes extraction conditions indicating a measurement device, measurement package, measurement port, service type, request information, and a specified range. The request information is information specifying the type of information and measurement type to be extracted, such as “abnormal, delay” and “trouble, delay”. The specified range indicates a range of information to be extracted from the recorded contents of the packet information database 12g. In the example shown in FIG. 33, since the specified range is “source IP address and source port number”, information indicating the “source IP address” and “source port number” is extracted from the recorded contents of the packet information database 12g.

Go back to the sequence view. Through the processing in the information recording section 1a, the management support apparatus 1 receives the information request from the trouble processing section 1e, extracts the quality abnormality information and trouble information associated with the packet information based on the received information request, and sends the extracted quality abnormality information and trouble information to the trouble processing section 1e (S902).

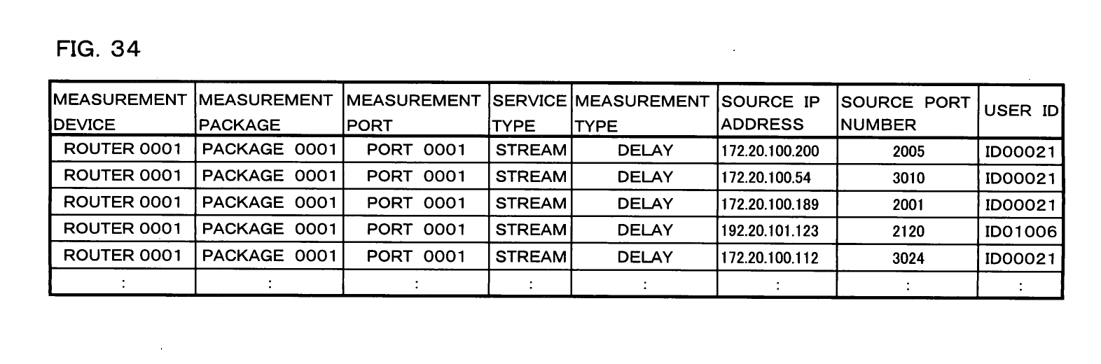

FIG. 34 is an explanatory view conceptually showing the quality abnormality information associated with the packet information in the management support apparatus 1 according to Embodiment 5 of the invention. In the quality abnormality information associated with the packet information indicating the recorded contents of the packet information database 12g as shown in FIG. 34, information indicating the source IP address, source port number and user ID which are the items of the packet information is associated with information indicating the measurement device, measurement package, measurement port, service type and measurement type which are the items of the original quality abnormality information.

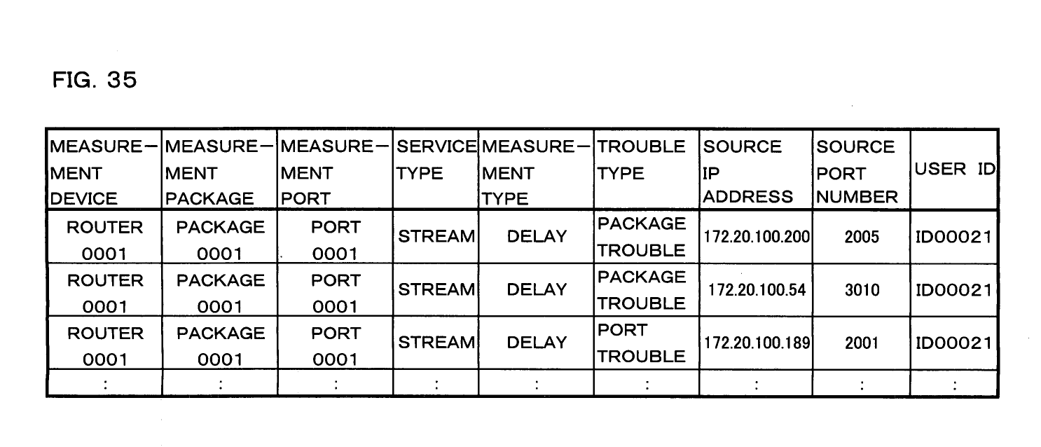

FIG. 35 is an explanatory view conceptually showing the trouble information associated with the packet information in the management support apparatus 1 according to Embodiment 5 of the invention. In the trouble information associated with the packet information indicating the recorded contents of the packet information database 12g as shown in FIG. 35, information indicating the source IP address, source port number and user ID which are the items of the packet information is associated with information indicating the measurement device, measurement package, measurement port, service type, measurement type and trouble type which are the items of the original trouble information.

Go back to the sequence view. Through the processing in the trouble processing section 1e, the management support apparatus 1 specifies the cause of the trouble from the quality abnormality information and trouble information in step S114 and the quality abnormality information and trouble information associated with the packet information received in step S902. (S903).

In step S114, the trouble information shown in FIG. 11 of Embodiment 1 is generated. The management support apparatus 1 detects from the trouble information and the quality abnormality information shown in FIG. 9 of Embodiment 1 that a quality abnormality and a trouble have occurred in the service type “stream” of the measurement device “Router 0001”—measurement package “Package 0001”—measurement port “Port 0001”. Since it is found from the quality abnormality information and trouble information associated with the packet information shown in FIGS. 33 and 34 that the source IP address and source port number common to the detected quality abnormality and trouble are the source IP address “172.20.100.xxx” and the source port number “20xx” or “30xx”, it is possible to specify this source IP address and source port number as the cause of the quality abnormality and trouble.

Moreover, since it is found from the quality abnormality information and trouble information associated with the packet information shown in FIGS. 33 and 34 that the user ID common to the detected quality abnormality and trouble is the user ID “ID00021”, it is possible to specify that this user ID is the user ID indicating a user who caused the quality abnormality and trouble. By recording attribute information indicating various attributes relating to the communication in addition to the above-described packet information and user information in association with each other, it is possible to review the information concerning various attributes that may cause quality abnormalities and troubles.

Thus, in Embodiment 5, it is possible to predict the tendency of quality abnormalities, based on the information concerning packets transmitted and received over the communication network, without depending on the technique or knowledge of the person in charge.

### Embodiment 6

Embodiment 6 is a mode according to Embodiment 1, and detects a trouble by additionally taking into account the past network operation results. Since the structure of a management support system according to Embodiment 6 is the same as in Embodiment 1, the explanation thereof is omitted by referring to Embodiment 1.

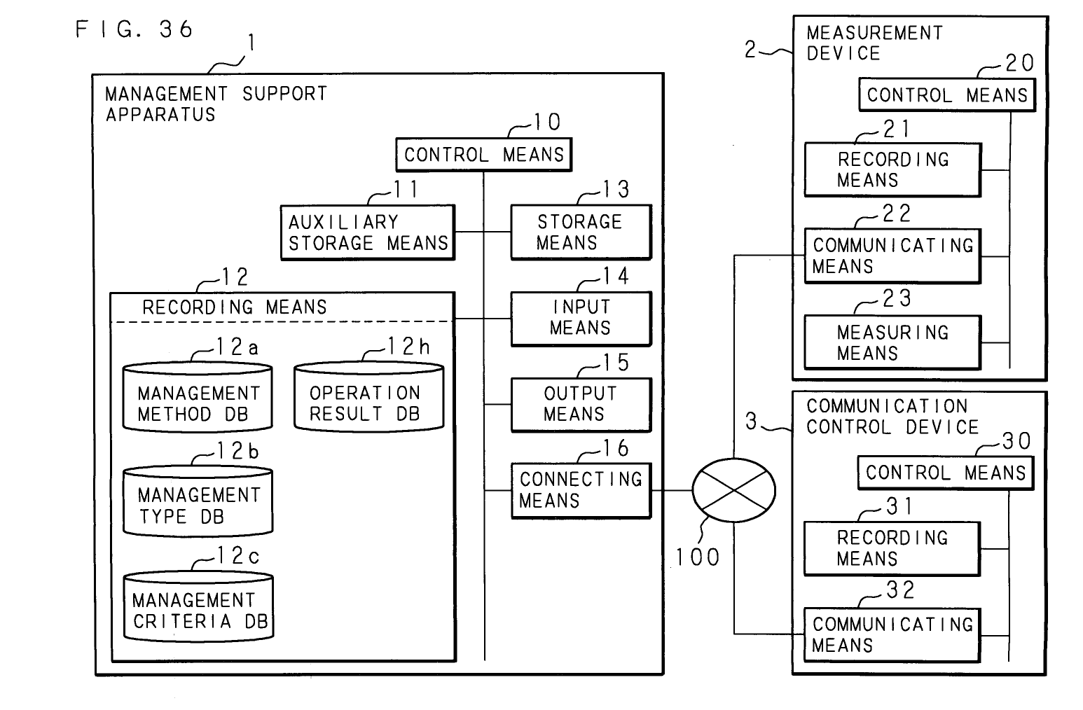

FIG. 36 is a block diagram showing the structure of a management support apparatus 1 according to Embodiment 6 of the invention. In the following explanation, the structures similar to those in Embodiment 1 will be designated with the same codes as in Embodiment 1, and the explanation thereof is omitted by referring to Embodiment 1. In the recording means 12 of the management support apparatus 1, the management method database 12a, management type database 12b, management criteria database 12c, and operation result database 12h are formed as databases to be managed in the information recording section 1a. Note that the operation result database 12h is not necessarily formed in the recording means 12 of the management support apparatus 1, and may be formed in recording means of other device if it can be managed in the information recording section 1a. The information to be recorded in these databases are received by some method, such as reading from an information recording medium by the auxiliary storage means 11, receiving an operation from the input means 14, and reception through the connecting means 16.

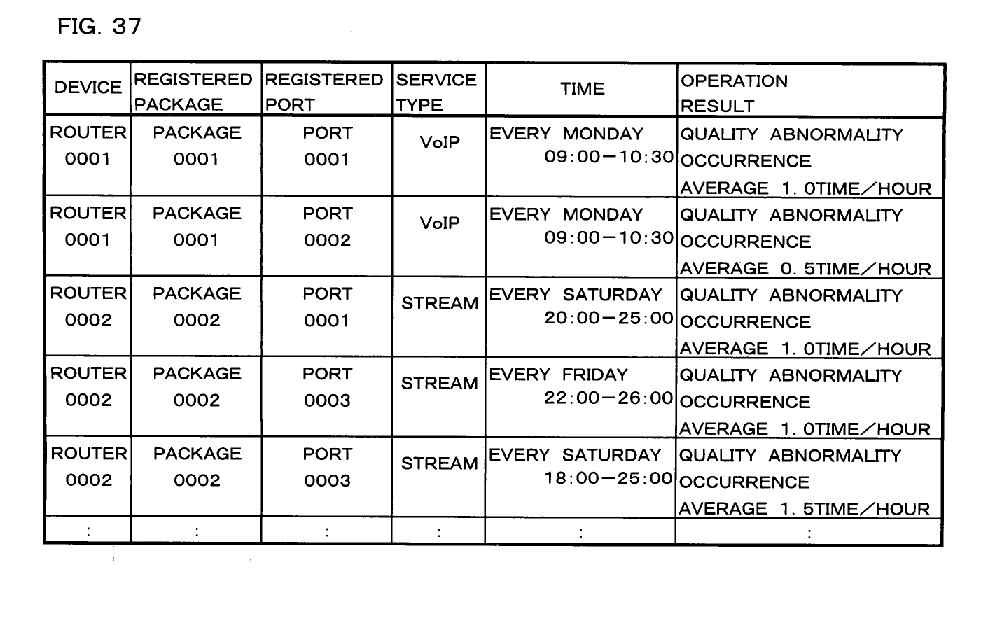

FIG. 37 is, an explanatory view conceptually showing the recorded contents of the operation result database 12h in the management support apparatus 1 according to Embodiment 6 of the invention. In the operation result database 12h, various kinds of information about a record that associates items such as the device (communication network device), registered package, registered port, service type, time, and operation results with each other are recoded as operation result information indicating the past operation results of a communication service provided through the communication network 100. In the Time field, information such as “Every Monday, 09:00-10:30” indicating a time range in which the past operation results were collected is recorded. Recorded in the Operation Result field is information such as “quality abnormality occurrence: average 1.0 time/hour” indicating the accumulation result of the past operation results in the time range indicated in the Time field.

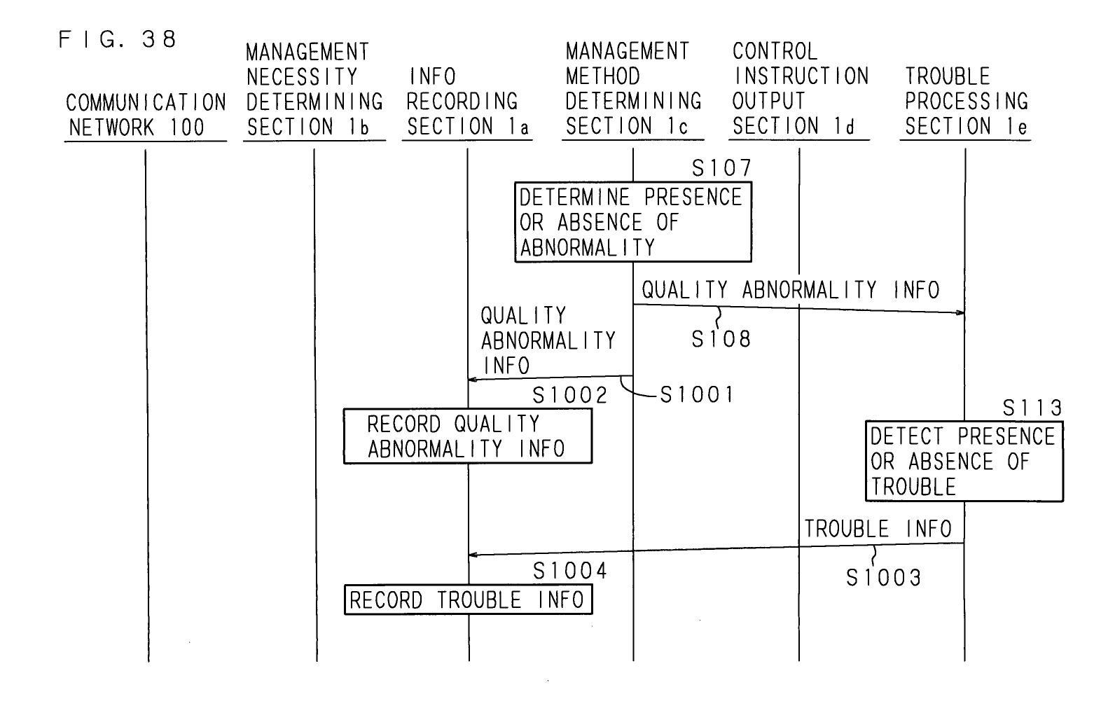

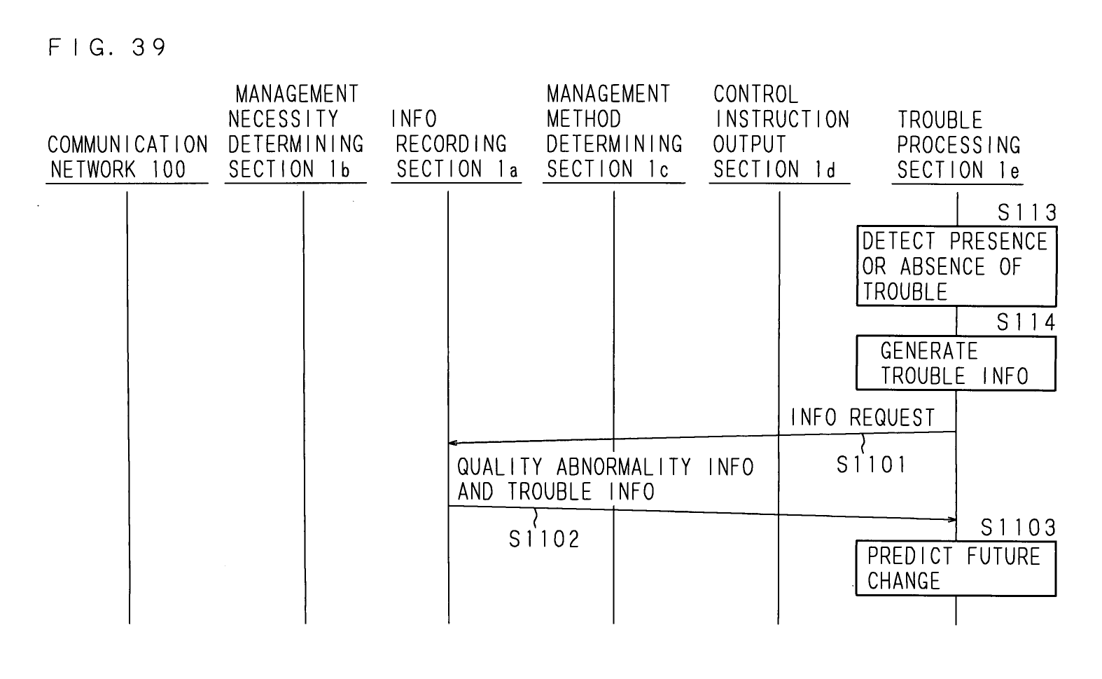

FIG. 38 is a sequence view showing a result recording process performed in the management support apparatus 1 according to Embodiment 6 of the invention. Regarding the processes explained in Embodiment 1, the detailed explanation is omitted by referring to Embodiment 1. Moreover, the same processes as in Embodiment 1 will be explained by designating the same step numbers. The management support apparatus 1 executes the processes of steps S101 to S107 explained in Embodiment 1, and determines whether or not an abnormality has occurred in the communication quality (S107). When a determination is made that an abnormality has occurred in the communication quality, the management support apparatus 1 sends the quality abnormality information to the trouble processing section 1e through the processing in the management method determining section 1c (S108), and further sends the quality abnormality information to the information recording section 1a (S1001).

Through the processing in the information recording section 1a, the management support apparatus 1 records the quality abnormality information received from the management method determining section 1c in the recording means 12 in association with the operation result information indicating the recorded contents of the operation result database 12h (S1002).

The quality abnormality information to be recorded in the recording means 12 in step S1002 is the quality abnormality information explained in Embodiment 1 using FIG. 9. By using the measurement device, measurement package and measurement port as key information, the quality abnormality information is recorded in association with a record where information shown in the fields of Device, Registered Package, and Registered Port in the operation result database 12h is the same as the key information. Note that the quality abnormality information may be formed in recording means of other device if it is managed in the information recording section 1a.

Through the processing in the trouble processing section 1e, the management support apparatus 1 detects the presence or absence of troubles that may cause quality abnormalities, based on the information such as the quality abnormality information received from the management method determining section 1c (S113), and generates trouble information and sends it to the information recording section 1a if a determination is made that a trouble has occurred (S1003).

Through the processing in the information recording section 1a, the management support apparatus 1 records the trouble information received from the trouble processing section 1e in the recording means 12 in association with the operation result information indicating the recorded contents of the operation result database 12h (S1004).

The trouble information to be recorded in the recording means 12 in step S1004 is the trouble information explained in Embodiment 1 using FIG. 11. By using the measurement device, measurement package and measurement port as key information, the trouble information is recorded in association with a record where information indicated in the fields of Device, Registered Package, and Registered Port in the operation result database 12h is the same as the key information. Note that the trouble information may be recorded in recording means of other device if it is managed in the information recording section 1a.

In this manner, the management support apparatus 1 according to Embodiment 6 of the present invention records the quality abnormality information and trouble information in association with the operation result database 12h.

FIG., 39 is a sequence view showing a trouble detecting process performed in the management support apparatus 1 according to Embodiment 6 of the invention. As explained in Embodiment 1, through the processing in the trouble processing section 1e, the management support apparatus 1 detects the presence or absence of troubles that may cause quality abnormalities, based on the trigger information notification received from the management necessity determining section 1b, the quality abnormality information received from the management method determining section 1c, and the determination criteria information extracted from the management criteria database 12c (S113), and generates the trouble information (S114).

Through the processing in the trouble processing section 1e, the management support apparatus 1 sends an information request for requesting the quality abnormality information and trouble information associated with the operation result information recorded in the operation result database 12h to the information recording section 1a (S1101).

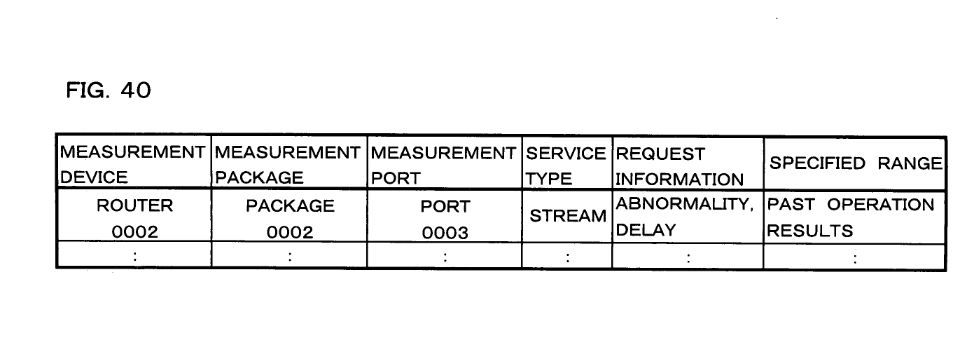

FIG. 40 is an explanatory view conceptually showing the information request in-the management support apparatus 1 according to Embodiment 6 of the invention. The information request is an instruction indicating the conditions for extracting the quality abnormality information and trouble information associated with the recorded contents of the operation result database 12h, and includes extraction conditions indicating a measurement device, measurement package, measurement port, service type, request information, and specified range. The request information is information that specifies the type of information to be extracted and a measurement type, such as “abnormality, delay” and “trouble, delay”. The specified range is information indicating a range of information to be extracted from the recorded contents of the operation result database 12h, and “the past operation results” is specified in the example shown in FIG. 40.

Go back to the sequence view. Through the processing in the information recording section 1a, the management support apparatus 1 receives the information request from the trouble processing section 1e, extracts the quality abnormality information and trouble information associated with the operation result information, based on the received information request, and sends the extracted quality abnormality information and trouble information to the trouble processing section 1e (S1102).

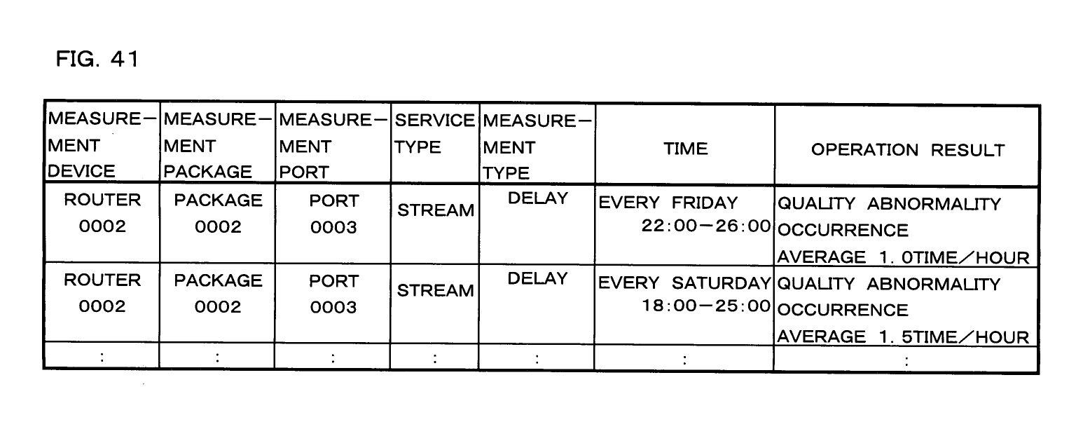

FIG. 41 is an explanatory view conceptually showing the quality abnormality information associated with operation result information in the management support apparatus 1 according to Embodiment 6 of the invention. In the quality abnormality information associated with the operation result information indicating the recorded contents of the operation result database 12h as shown in FIG. 41, the information indicating time and operation results which are the items of the operation result information is associated with the information indicating a measurement device, measurement package, measurement port, service type, and measurement type which are the items of the original quality abnormality information.

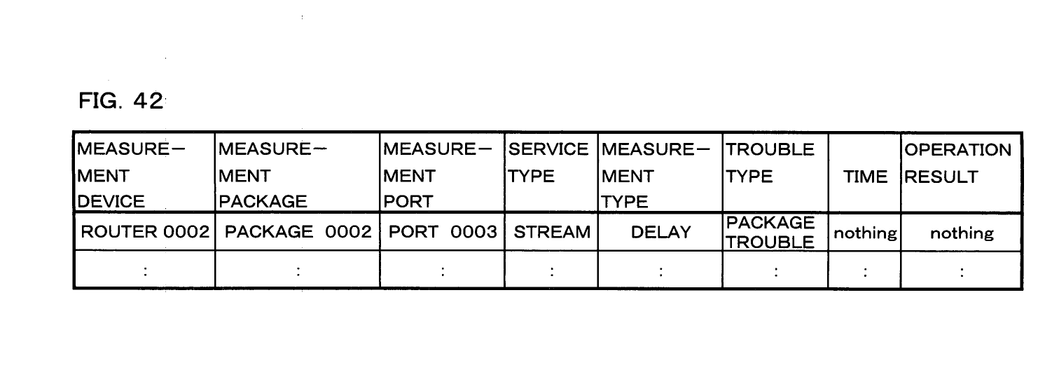

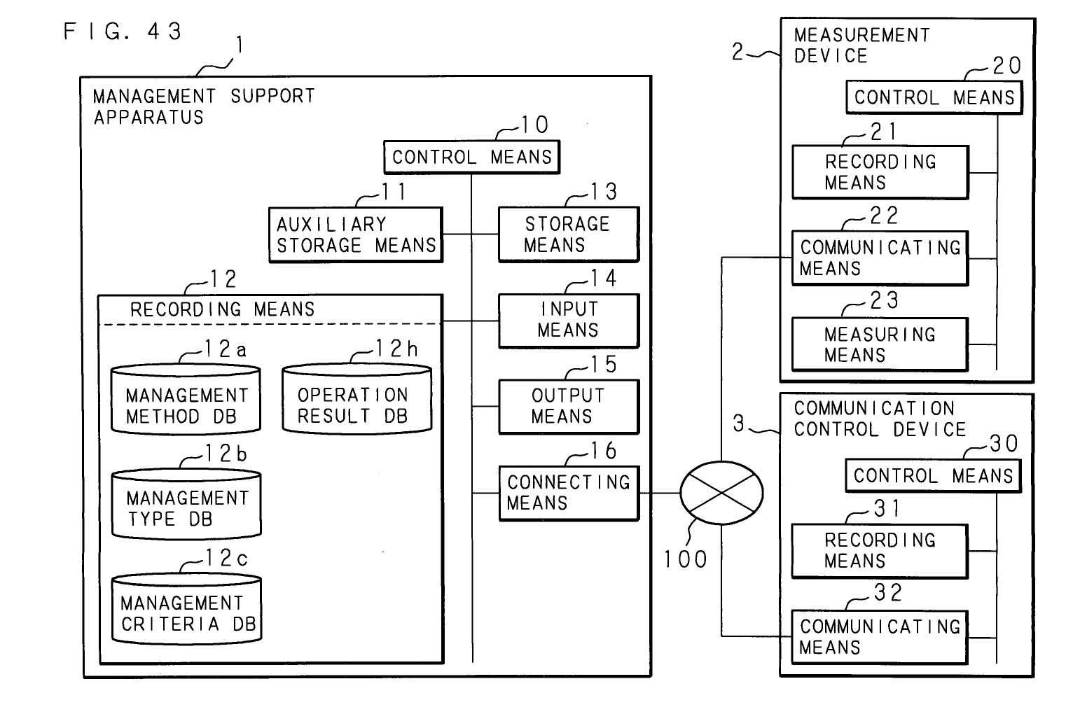

FIG. 42 is an explanatory view conceptually showing the trouble information associated with the packet information in the management support apparatus 1 according to Embodiment 6 of the invention. In the trouble information associated with the operation result information indicating the recorded contents of the operation result database 12h as shown in FIG. 42, the information indicating time and operation results which are the items of the operation result information is associated with the information indicating a measurement device, measurement package, measurement port, service type, measurement type, and trouble type which are the items of the original trouble information.

Go back to the sequence view. Through the processing in the trouble processing information 1e, the management support apparatus 1 predicts a future change in the trouble from the trouble information and quality abnormality information in step S114 and the quality abnormality information and trouble information associated with the operation result information received in step S1102 (S1103).

In step S114, the trouble information shown in FIG. 11 of Embodiment 1 is generated. Moreover, the management support apparatus 1 detects from the trouble information and the quality abnormality information shown in FIG. 9 of Embodiment 1 that a quality abnormality and a trouble have occurred in the service type “delay” of the measurement device “Router 0002”—measurement package “Package 0002”—measurement port “Port 0003”. Then it is found from the second record shown in FIG. 41 that, at the time “every Saturday 18:00-25:00”, the operation result is “quality abnormally occurrence: average 1.5 times/hour”. For example, if the determination time in this process is Saturday 15:30, then it is possible to predict that there is a high possibility of a further increase in delay hereafter.

Thus, in Embodiment 6, it is possible to predict the tendency of troubles in the future, and predict and analyze the tendency of quality abnormalities, based on the past operation results, without depending on the technique or knowledge of the person in charge.

### Embodiment 7

Embodiment 7 is a mode according to Embodiment 1, and manages abnormalities in the communication quality by additionally taking into account the past network operation results. Since the structure of a management support system according to Embodiment 7 is the same as in Embodiment 1, the explanation thereof is omitted by referring to Embodiment 1.

FIG. 43 is a block diagram showing the structure of a management support apparatus according to Embodiment 7 of the invention. In the following explanation, the components similar to those in Embodiment 1 will be designated with the same codes as in Embodiment 1, and the explanation thereof is omitted by referring to Embodiment 1. In the recording means 12 of the management support apparatus 1, the management method database 12a, management type database 12b, management criteria database 12c, and operation result database 12h are formed as databases to be managed in the information recording section 1a. The explanation of the recorded contents concerning the operation result database 12h and the recording process is omitted by referring to the explanation using FIGS. 36 and 38 of Embodiment 6.

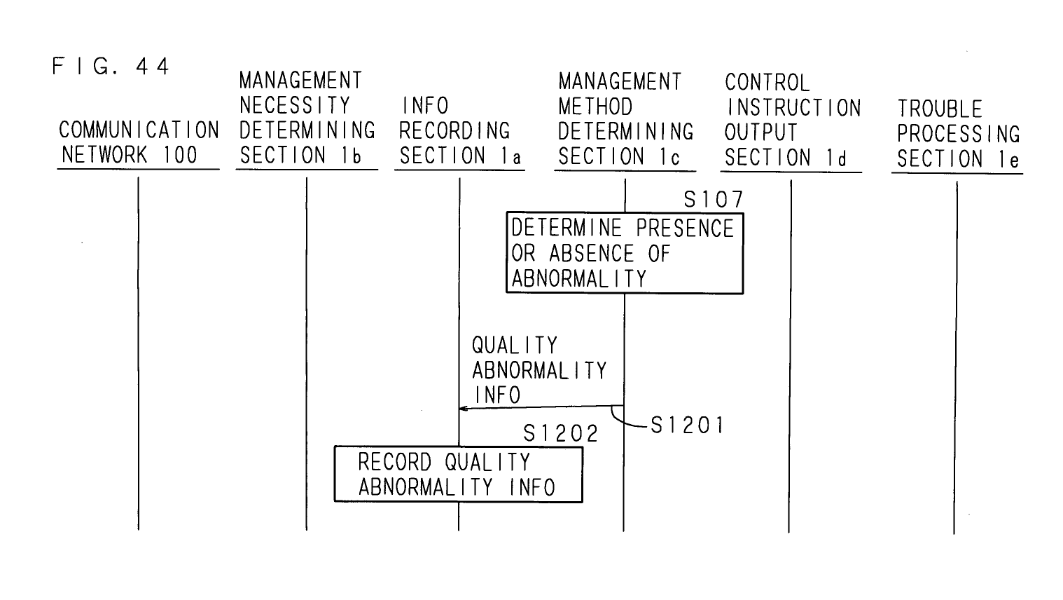

FIG. 44 is a sequence view showing the processes performed in the management support apparatus 1 according to Embodiment 7 of the invention. Regarding the processes explained in Embodiment 1, the detailed explanation is omitted by referring to Embodiment 1. Moreover, the same processes as in Embodiment 1 will be explained by designating the same step numbers. The management support apparatus 1 executes the processes of steps S101 to S107 explained in Embodiment 1, and determines whether or not an abnormality has occurred in the communication quality (S107). When a determination is made that an abnormality has occurred in the communication quality, the management support apparatus 1 sends the quality abnormality information to the trouble processing section 1a through the processing in the management method determining section 1c (S1201).

Through the processing in the information recording section 1a, the management support apparatus 1 records the quality abnormality information received from the management method determining section 1c in the recording means 12 in association with the operation result information indicating the recorded contents of the operation result database 12h (S1202).

The quality abnormality information to be recorded in the recording means 12 in step S1202 is the quality abnormality information explained in Embodiment 1 using FIG. 9. By using the measurement device, measurement package and measurement port as key information, the quality abnormality information is recorded in association with a record where information shown in the fields of Device, Registered Package, and Registered Port in the operation result database 12h is the same as the key information. Note that the operation result database 12h is not necessarily formed in the recording means 12 of the management support apparatus 1, and the quality abnormality information may be recorded in recording means of other device if it is managed in the information recording section 1a.

In this manner, the management support apparatus 1 according to Embodiment 7 of the present invention records the quality abnormality information in association with the operation result database 12h.

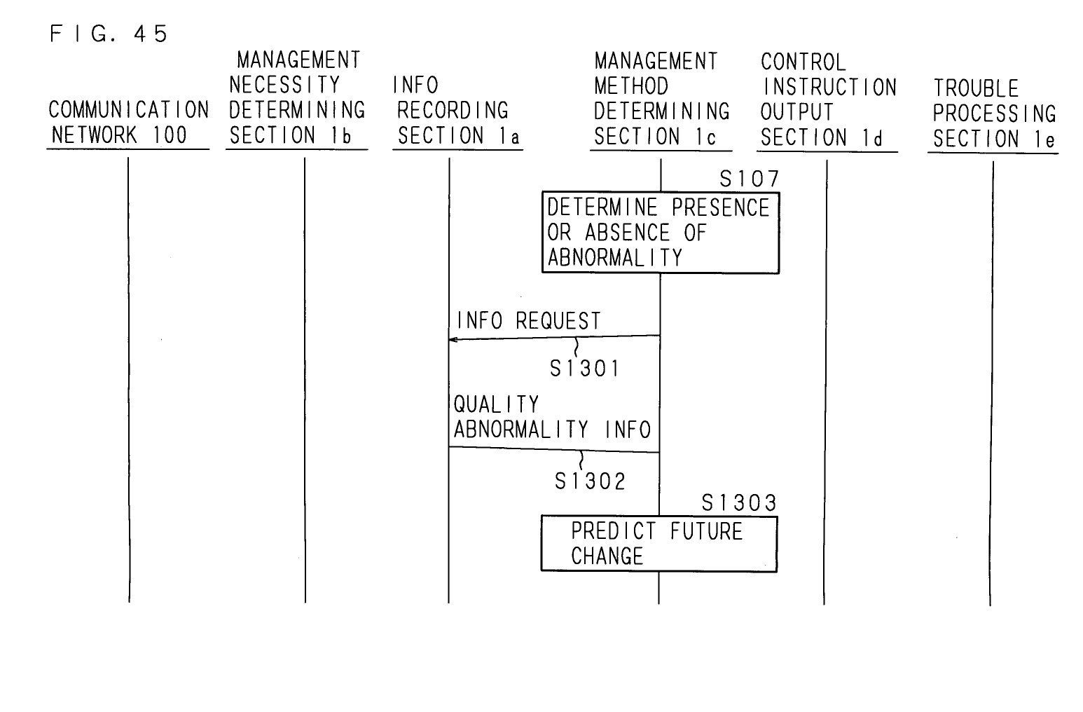

FIG. 45 is a sequence view showing a quality abnormality managing process performed in the management support apparatus 1 according to Embodiment 7 of the invention. Through the processing in the management method determining section 1c, the management support apparatus 1 determines the presence or absence of abnormalities in the communication quality, based on the determination criteria information and the trigger information notification as explained in Embodiment 1 (S107).

Through the processing in the management method determining section 1c, the management support apparatus 1 sends an information request for requesting the quality abnormality information associated with the operation result information recorded in the operation result database 12h to the information recording section 1a (S1301).

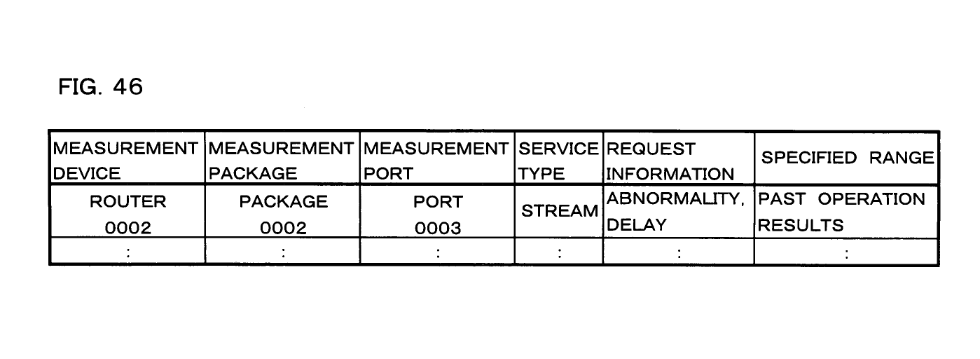

FIG. 46 is an explanatory view conceptually showing the information request in the management support apparatus 1 according to Embodiment 7 of the invention. The information request is an instruction indicating the conditions for extracting the quality abnormality information associated with the recorded contents of the operation result database 12h, and includes extraction conditions indicating a measurement device, measurement package, measurement port, service type, request information, and specified range. The request information is information for specifying the type of information to be extracted and a measurement type, such as “abnormal, delay”. The specified range is information indicating a range of information to be extracted from the recorded contents of the operation result database 12h. The “past operation results” are specified in the example shown in FIG. 46.

Go back to the sequence view. Through the processing in the information recording section 1a, the management support apparatus 1 receives the information request from the management method determining section 1c, extracts the quality abnormality information associated with the operation result information based on the received information request, and sends the extracted quality abnormality information to the management method determining section 1c (S1302).

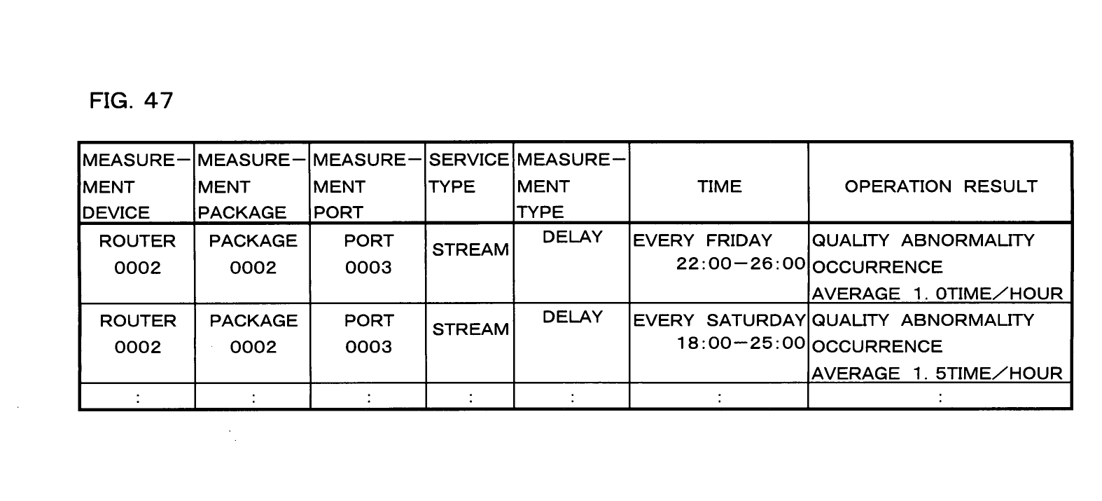

FIG. 47 is an explanatory view conceptually showing the quality abnormality information associated with the operation result information in the management support apparatus 1 according to Embodiment 7 of the invention. In the quality abnormality information associated with the operation result information indicating the recorded contents of the operation result database 12h as shown in FIG. 47, the information indicating time and operation results which are the items of the operation result information is associated with the information indicating a measurement device, measurement package, measurement port, service type, and measurement type which are the items of the original quality abnormality information.

Go back to the sequence view. Through the processing in the management method determining section 1c, the management support apparatus 1 predicts a future change in the communication quality from the quality abnormality information associated with the operation result information received in step S1302. (S1303).

If the time to execute the process in step S1303 is Saturday 15:30, for example, it is possible to predict that there is a high possibility of a further increase in delay hereafter. The quality abnormality information to be used as the basis for the prediction is based on the statistic result obtained by accumulating the past results of the operation result information and quality abnormality information, and it is possible to numerically predict the tendency of a change in the service state hereafter based on the statistic result, and it is possible to give various notifications, such as an alarm and improvement instruction.

Thus, in Embodiment 7, it is possible to predict the tendency of abnormalities in the communication quality, based on the past operation results, without depending on the technique or knowledge of the person in charge.

Embodiments 1 through 7 described above merely exemplify part of countless embodiments of the present invention, and it is possible to suitably set various kinds of instructions and information such as the structures of databases. For example, the communication services are not limited to “VoIP” and “stream”, and may be expanded in various forms. Moreover, with the accumulation of management know how corresponding to abnormalities and troubles, it is possible to expand communication services in various forms.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. A management support method using a management support apparatus for supporting management with respect to abnormalities in communication services, comprising the steps of:
measuring communication quality of a communication network that provides a plurality of types of communication services;
determining an abnormality type and whether management is necessary or not by comparing the measured communication quality with a preset criterion;
extracting information about management from a database in which information about management with respect to abnormalities is recorded in association with communication network devices constituting the communication network, service types of communication services and abnormality types, based on a communication network device, service type and abnormality type corresponding to the measured communication quality, when a determination is made that management is necessary; and
giving an output based on the extracted information.

2. A management support system for supporting management with respect to abnormalities in communication services, comprising:
a measurement device for measuring communication quality of a communication network that provides a plurality of types of communication services, for each of communication network devices constituting the communication network, and service types of communication services;
a management database for recording information about management with respect to abnormalities in association with communication network devices, service types, and abnormality types;
a controller capable of
determining an abnormality type and whether management is necessary or not by comparing the communication quality measured by the measurement device with a preset criterion, and
extracting information about management from the management database, based on a communication network device, service type and abnormality type corresponding to the measured communication quality, when a determination is made that management is necessary; and
an output section for giving an output based on the extracted information.

3. The management support system according to claim 2, further comprising a communication control device for performing control concerning a plurality of types of communication services provided by the communication network, wherein
said controller is further capable of extracting information about a control instruction for causing said communication control device to perform control concerning communication services.

4. The management support system according to claim 2, wherein said controller is further capable of extracting information indicating a trouble associated with a communication network device, service type and abnormality type as information about management.

5. The management support system according to claim 2, further comprising:
a trouble information result record database for recording trouble information indicating past trouble results in association with communication network devices, service types, and abnormality types, wherein
said controller is further capable of extracting trouble information from the trouble information result record database, based on a communication network device, service type, and abnormality type corresponding to the measured communication quality.

6. The management support system according to claim 2, further comprising:
a network structure database for recording information indicating communication network devices within a communication network connected to communication network devices in association with the communication network devices, wherein
said controller is further capable of extracting information indicating a communication network device within a communication network connected to a communication network device corresponding to the measured communication quality from the network structure database.

7. The management support system according to claim 2, further comprising:
an attribute database for recording attribute information showing attributes of communication network devices in association with information about the communication network devices, wherein
said controller is further capable of extracting the attribute information from the attribute database, based on information about a communication network device corresponding to the measured communication quality.

8. The management support system according to claim 7, wherein the attribute database records information about packets transmitted from the communication network devices as attribute information.

9. A management support system for supporting management with respect to abnormalities in communication services, comprising:
a measurement device for measuring communication quality of a communication network that provides a plurality of types of communication services, for each of communication network devices constituting the communication network, and service types of communication services;
a management database for recording information about management with respect to abnormalities in association with communication network devices, service types, and abnormality types;
means for determining an abnormality type and whether management is necessary or not by comparing the communication quality measured by the measurement device with a preset criterion;
extracting means for extracting information about management from the management database, based on a communication network device, service type and abnormality type corresponding to the measured communication quality, when a determination is made that management is necessary; and
means for giving an output based on the extracted information.

10. The management support system according to claim 9, further comprising a communication control device for performing control concerning a plurality of types of communication services provided by the communication network, wherein
said extracting means is constructed to extract information about a control instruction for causing said communication control device to perform control concerning communication services.

11. The management support system according to claim 9, wherein said extracting means is constructed to extract information indicating a trouble associated with a communication network device, service type and abnormality type as information about management.

12. The management support system according to claim 9, further comprising:
a trouble information result record database for recording trouble information indicating past trouble results in association with communication network devices, service types and abnormality types; and
means for extracting trouble information from the trouble information result record database, based on a communication network device, service type and abnormality type corresponding to the measured communication quality.

13. The management support system according to claim 9, further comprising:
a network structure database for recording information indicating communication network devices within a communication network connected to communication network devices in association with the communication network devices; and
means for extracting from the network structure database the information indicating a communication network device within a communication network connected to a communication network device corresponding to the measured communication quality.

14. The management support system according to claim 9, further comprising:
an attribute database for recording attribute information indicating attributes of communication network devices in association with information about the communication network devices; and
means for extracting the attribute information from the attribute database, based on information about a communication network device corresponding to the measured communication quality.

15. The management support system according to claim 14, wherein the attribute database records information about packets transmitted from the communication network devices as attribute information.

16. A management support apparatus for supporting management with respect to abnormalities in communication services, comprising:
a controller capable of:
obtaining communication quality measured for each of communication network devices constituting a communication network that provides a plurality of types of communication services, and service types of communication services;
determining an abnormality type and whether management is necessary or not by comparing the obtained communication quality with a preset criterion, and
extracting information about management from a management database in which information about management with respect to abnormalities is recoded, based on a communication network device, service type and abnormality type corresponding to the measured communication quality, when a determination is made that management is necessary; and
an output section for giving an output based on the extracted information.

17. A management support apparatus for supporting management with respect to abnormalities in communication services, comprising:
means for obtaining communication quality measured for each of communication network devices constituting a communication network that provides a plurality of types of communication services, and service types of communication services;
means for determining an abnormality type and whether management is necessary or not by comparing the obtained communication quality with a preset criterion;
means for extracting information about management from a management database in which information about management with respect to abnormalities is recorded, based on a communication network device, service type and abnormality type corresponding to the measured communication quality, when a determination is made that management is necessary; and
means for giving an output based on the extracted information.

18. A recording medium storing a computer program for causing a computer to support management with respect to abnormalities in communication services, said computer program comprising the steps of:
causing the computer to obtain communication quality measured for each of communication network devices constituting a communication network that provides a plurality of types of communication services, and service types of the communication services;
causing the computer to determine an abnormality type and whether management is necessary or not by comparing the obtained communication quality with a preset criterion; and
causing the computer to extract information about management from a database in which information about management with respect to abnormalities is recorded in association with communication network devices, service types, and abnormality types, based on a communication network device, service type and abnormality type corresponding to the measured communication quality, when a determination is made that management is necessary.
